(19) United States
(12) Patent Application Publication
(10) Pub. No.: US 2026/0009976 A1
(43) Pub. Date: Jan. 8, 2026

(54) PHOTOGRAPHING OPTICAL LENS SYSTEM, IMAGE CAPTURING UNIT AND ELECTRONIC DEVICE

(71) Applicant: LARGAN PRECISION CO., LTD., Taichung City (TW)

(72) Inventors: I-Chieh CHEN, Taichung City (TW); Zheng-Zhia HUANG, Taichung City (TW); Yu-Han SHIH, Taichung City (TW)

(73) Assignee: LARGAN PRECISION CO., LTD., Taichung City (TW)

(21) Appl. No.: 18/809,952

(22) Filed: Aug. 20, 2024

(30) Foreign Application Priority Data
Jul. 3, 2024 (TW) 113124847

(51) Int. Cl. G02B 13/00; G02B 1/04; G02B 5/00; G02B 9/12

(52) U.S. Cl. CPC G02B 13/0035; G02B 1/041; G02B 5/005; G02B 9/12; G02B 13/006

(57) ABSTRACT

A photographing optical lens system includes three lens elements which are, in order from an object side to an image side: a first lens element, a second lens element and a third lens element. Each of the three lens elements has an object-side surface facing toward the object side and an image-side surface facing toward the image side. The image-side surface of the first lens element is concave in a paraxial region thereof. The third lens element has negative refractive power. The photographing optical lens system further includes an aperture stop disposed between the first lens element and the second lens element.

### RELATED APPLICATIONS

This application claims priority to Taiwan Application 113124847, filed on Jul. 3, 2024, which is incorporated by reference herein in its entirety.

### BACKGROUND

### Technical Field

The present disclosure relates to a photographing optical lens system, an image capturing unit and an electronic device, more particularly to a photographing optical lens system and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, a photographing optical lens system includes three lens elements. The three lens elements are, in order from an object side to an image side along an optical path, a first lens element, a second lens element and a third lens element. Each of the three lens elements has an object-side surface facing toward the object side and an image-side surface facing toward the image side.

Preferably, the image-side surface of the first lens element is concave in a paraxial region thereof. Preferably, the third lens element has negative refractive power. Preferably, the photographing optical lens system further includes an aperture stop disposed between the first lens element and the second lens element.

When an axial distance between the object-side surface of the first lens element and an image surface is TL, a focal length of the photographing optical lens system is f, a central thickness of the first lens element is CT1, a central thickness of the second lens element is CT2, a central thickness of the third lens element is CT3, a curvature radius of the object-side surface of the third lens element is R5, a curvature radius of the image-side surface of the third lens element is R6, and an f-number of the photographing optical lens system is Fno, the following conditions are preferably satisfied:

$$\begin{matrix}1.8 < TL / f < 5.1 ; \\ 1.75 < ( CT 2 + CT 3 ) / CT 1 < 6.5 ; \\ 0.4 < CT 2 / CT 3 < 2.5 ; \\ - 1.2 < R 5 / R 6 < 0.39 ; and \\ 2.6 < Fno < 5.1 .\end{matrix}$$

According to another aspect of the present disclosure, a photographing optical lens system includes three lens elements. The three lens elements are, in order from an object side to an image side along an optical path, a first lens element, a second lens element and a third lens element. Each of the three lens elements has an object-side surface facing toward the object side and an image-side surface facing toward the image side.

Preferably, the third lens element has negative refractive power.

When an axial distance between the object-side surface of the first lens element and an image surface is TL, a focal length of the photographing optical lens system is f, a composite focal length of the first lens element and the second lens element is f12, a central thickness of the first lens element is CT1, a central thickness of the second lens element is CT2, a central thickness of the third lens element is CT3, an axial distance between the first lens element and the second lens element is T12, a curvature radius of the object-side surface of the first lens element is R1, a curvature radius of the image-side surface of the second lens element is R4, a curvature radius of the object-side surface of the third lens element is R5, and a curvature radius of the image-side surface of the third lens element is R6, the following conditions are preferably satisfied:

$$\begin{matrix}2.3 < TL / f < 4.8 ; \\ 1.75 < ( CT 2 + CT 3 ) / CT 1 < 6.5 ; \\ 1.2 < T 12 / CT 1 < 4.2 ; \\ 0.5 < R 5 / R 4 < 3.3 ; \\ - 0.6 < f / R 1 + f / R 6 < 1.5 ; and \\ 0.9 < f / f 12 < 4. .\end{matrix}$$

According to another aspect of the present disclosure, an image capturing unit includes one of the aforementioned photographing optical lens systems and an image sensor, wherein the image sensor is disposed on the image surface of the photographing optical lens system.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a perspective view of an image capturing unit according to the 9th embodiment of the present disclosure;

FIG. 18 is one perspective view of an electronic device according to the 10th embodiment of the present disclosure;

FIG. 19 is another perspective view of the electronic device in FIG. 18;

FIG. 20 is a block diagram of the electronic device in FIG. 18;

FIG. 21 is one schematic view of an electronic device according to the 11th embodiment of the present disclosure;

FIG. 22 is another schematic view of the electronic device in FIG. 21;

FIG. 23 is one perspective view of an electronic device according to the 12th embodiment of the present disclosure;

FIG. 24 is a cross-sectional view of an electronic device according to the 13th embodiment of the present disclosure;

FIG. 25 is one perspective view of an electronic device according to the 14th embodiment of the present disclosure;

FIG. 26 shows a schematic view of Y1R2, Y2R1, ET1, ET3 and SAG3R2 according to the 2nd embodiment of the present disclosure;

FIG. 27 shows a schematic view of a configuration of one light-folding element in a photographing optical lens system according to one embodiment of the present disclosure;

FIG. 28 shows a schematic view of another configuration of one light-folding element in a photographing optical lens system according to one embodiment of the present disclosure; and

FIG. 29 shows a schematic view of a configuration of two light-folding elements in a photographing optical lens system according to one embodiment of the present disclosure.

### DETAILED DESCRIPTION

A photographing optical lens system includes three lens elements. The three lens elements are, in order from an object side to an image side along an optical path, a first lens element, a second lens element and a third lens element. Each of the three lens elements of the photographing optical lens system has an object-side surface facing toward the object side and an image-side surface facing toward the image side.

The first lens element can have negative refractive power. Therefore, it is favorable for enlarging the field of view to obtain a wider range of image information. The image-side surface of the first lens element can be concave in a paraxial region thereof. Therefore, it is favorable for receiving wide-angle light to achieve a larger photographic range.

The second lens element can have positive refractive power. Therefore, it is favorable for effectively converging light to reduce the size of the photographing optical lens system. The object-side surface of the second lens element can be convex in a paraxial region thereof. Therefore, it is favorable for correcting spherical aberration to improve image quality. The image-side surface of the second lens element can be convex in a paraxial region thereof. Therefore, it is favorable for providing the second lens element with the capability to converge light, preventing ineffective light focusing due to insufficient light refraction in the peripheral area.

The third lens element can have negative refractive power. Therefore, it is favorable for balancing the overall distribution of refractive power and controlling the back focal length to meet application requirements. The object-side surface of the third lens element can be concave in a paraxial region thereof. Therefore, it is favorable for mitigating the incident light from a wide angle and correcting aberrations.

According to the present disclosure, the photographing optical lens system can further include an aperture stop disposed between the first lens element and the second lens element. Therefore, it is favorable for adjusting the position of the aperture stop to achieve a balance between the field of view, total track length, depth of field, and image illuminance.

At least one of the object-side surface of the first lens element and the image-side surface of the third lens element can be planar in a paraxial region thereof. Therefore, it is favorable for aligning with the production process to enhance product manufacturability. Moreover, the object-side surface of the first lens element can be planar in the paraxial region thereof and can be cemented to a plate. Moreover, the image-side surface of the third lens element can be planar in the paraxial region thereof and can be cemented to a plate. The plate is favorable for the shaping of the lens element and the assembly of the photographing optical lens system. Moreover, the plate can be made of materials such as glass or plastic. Moreover, the fixing method between the lens element and the plate can include techniques such as adhesive bonding, etching, or nanoimprinting, but the present disclosure is not limited thereto.

According to the present disclosure, the photographing optical lens system can be configured for capturing images of an imaged object when an object distance is within a range of 30 millimeters (mm) or less. Therefore, it is favorable for the photographing optical lens system to be applied in close-up photography, thereby increasing the product application fields and usage scenarios. Moreover, the photographing optical lens system can also be configured for capturing images of an imaged object when an object distance is within a range of 20 mm or less. Moreover, the photographing optical lens system can also be configured for capturing images of an imaged object when an object distance is within a range of 10 mm or less.

When an axial distance between the object-side surface of the first lens element and an image surface is TL, and a focal length of the photographing optical lens system is f, the following condition is satisfied: 1.80<TL/f<5.10. Therefore, it is favorable for effectively controlling the relationship between the total track length and the field of view of the photographing optical lens system to achieve wide-angle application purposes. Moreover, the following condition can also be satisfied: 2.00<TL/f<4.80. Moreover, the following condition can also be satisfied: 2.30<TL/f<4.80. Moreover, the following condition can also be satisfied: 2.50≤TL/f≤4.45.

When a central thickness of the first lens element is CT1, a central thickness of the second lens element is CT2, and a central thickness of the third lens element is CT3, the following condition is satisfied: 1.75<(CT2+CT3)/CT1<6.50. Therefore, it is favorable for coordinating the arrangement design of the refractive power of lens elements, increasing the field of view of the photographing optical lens system, and controlling the thicknesses of lens elements to reduce manufacturing tolerances and improve yield. Moreover, the following condition can also be satisfied: 1.85<(CT2+CT3)/CT1<6.00. Moreover, the following condition can also be satisfied: 1.99≤(CT2+CT3)/CT1≤5.72.

When the central thickness of the second lens element is CT2, and the central thickness of the third lens element is CT3, the following condition can be satisfied: 0.40<CT2/CT3<2.50. Therefore, it is favorable for balancing the spatial configuration of the photographing optical lens system to reduce sensitivity and enhance manufacturability. Moreover, the following condition can also be satisfied: 0.55<CT2/CT3<2.40. Moreover, the following condition can also be satisfied: 0.65<CT2/CT3<2.30. Moreover, the following condition can also be satisfied: 0.85≤CT2/CT3≤2.09.

When a curvature radius of the object-side surface of the third lens element is R5, and a curvature radius of the image-side surface of the third lens element is R6, the following condition can be satisfied: —2.00<R5/R6<0.35. Therefore, it is favorable for adjusting the shape and refractive power of the third lens element to correct field curvature and distortion. Moreover, the following condition can also be satisfied: −1.20<R5/R6<0.39. Moreover, the following condition can also be satisfied: −0.90<R5/R6<0.30. Moreover, the following condition can also be satisfied: −0.54≤R5/R6≤0.20.

When an f-number of the photographing optical lens system is Fno, the following condition can be satisfied: 2.60<Fno<5.10. Therefore, it is favorable for adjusting the size of aperture stop to achieve a balance between image illuminance, depth of field, and image quality. Moreover, the following condition can also be satisfied: 2.80<Fno<4.90. Moreover, the following condition can also be satisfied: 3.30≤Fno≤4.70.

When an axial distance between the first lens element and the second lens element is T12, and the central thickness of the first lens element is CT1, the following condition can be satisfied: 1.20<T12/CT1<5.00. Therefore, it is favorable for aligning with wide-angle design, and it is favorable for adjusting the light path on the object side of the photographing optical lens system. Moreover, the following condition can also be satisfied: 1.30<T12/CT1<4.60. Moreover, the following condition can also be satisfied: 1.20<T12/CT1<4.20. Moreover, the following condition can also be satisfied: 1.66≤T12/CT1≤3.85.

When a curvature radius of the image-side surface of the second lens element is R4, and the curvature radius of the object-side surface of the third lens element is R5, the following condition can be satisfied: 0.50<R5/R4<3.30. Therefore, it is favorable for the second lens element and the third lens element to work together to adjust the light refraction angle, thereby improving imaging quality. Moreover, the following condition can also be satisfied: 0.65<R5/R4<3.00. Moreover, the following condition can also be satisfied: 0.85<R5/R4<2.80. Moreover, the following condition can also be satisfied: 1.19≤R5/R4≤2.55.

When the focal length of the photographing optical lens system is f, a curvature radius of the object-side surface of the first lens element is R1, and the curvature radius of the image-side surface of the third lens element is R6, the following condition can be satisfied: −0.60<f/R1+f/R6<1.50. Therefore, it is favorable for adjusting the incident angle of light entering the photographing optical lens system and the incident angle of light reaching the image surface, effectively enhancing the light-gathering quality of the paraxial field of view. Moreover, the following condition can also be satisfied: −0.55<f/R1+f/R6<1.30. Moreover, the following condition can also be satisfied: −0.45<f/R1+f/R6<1.10. Moreover, the following condition can also be satisfied: −0.32≤f/R1+f/R6≤0.90.

When the focal length of the photographing optical lens system is f, and a composite focal length of the first lens element and the second lens element is f12, the following condition can be satisfied: 0.90<f/f12<4.00. Therefore, it is favorable for enhancing light convergence to effectively reduce the size of the photographing optical lens system. Moreover, the following condition can also be satisfied: 1.25<f/f12<3.30. Moreover, the following condition can also be satisfied: 1.67≤f/f12≤2.93.

When an axial distance between the second lens element and the third lens element is T23, and the central thickness of the third lens element is CT3, the following condition can be satisfied: 0.03<T23/CT3<3.00. Therefore, it is favorable for adjusting the ratio between the position and the central thickness of the third lens element, adjusting the light path on the image side of the photographing optical lens system to improve image quality. Moreover, the following condition can also be satisfied: 0.05<T23/CT3<2.50. Moreover, the following condition can also be satisfied: 0.05<T23/CT3<2.00.

When the focal length of the photographing optical lens system is f, a focal length of the first lens element is f1, a focal length of the second lens element is f2, and a focal length of the third lens element is f3, the following condition can be satisfied: −1.50<f/f1+f/f2+f/f3<0.20. Therefore, balancing the overall distribution of refractive power in the photographing optical lens system is favorable for aberration correction. Moreover, the following condition can also be satisfied: −1.20<f/f1+f/f2+f/f3<0.15. Moreover, the following condition can also be satisfied: −1.00<f/f1+f/f2+f/f3<0.10. According to the present disclosure, a focal length of a single lens element is calculated based on the condition that the media in front of and behind the single lens element are both air.

When the central thickness of the first lens element is CT1, and the central thickness of the second lens element is CT2, the following condition can be satisfied: 0.15<CT1/CT2<1.05. Therefore, it is favorable for adjusting the ratio of central thickness between the first lens element and the second lens element to achieve a balance between the molding yields of the first lens element and the second lens element and the total track length of the photographing optical lens system. Moreover, the following condition can also be satisfied: 0.20<CT1/CT2<1.00. Moreover, the following condition can also be satisfied: 0.25<CT1/CT2<0.95.

When a maximum image height of the photographing optical lens system (which can be half of a diagonal length of an effective photosensitive area of an image sensor) is ImgH, and the focal length of the photographing optical lens system is f, the following condition can be satisfied: 0.65<ImgH/f<1.50. Therefore, appropriately controlling the ratio of image height to focal length is favorable for the miniaturization of the photographing optical lens system while increasing the image surface area to capture more light.

When an axial distance between the image-side surface of the third lens element and the image surface is BL, and an axial distance between the object-side surface of the first lens element and the image-side surface of the third lens element is TD, the following condition can be satisfied: 0.10<BL/TD<0.60. Therefore, it is favorable for achieving a balance between the size and manufacturability of the photographing optical lens system.

When the focal length of the photographing optical lens system is f, and the focal length of the third lens element is f3, the following condition can be satisfied: −3.00<f/f3<−0.30. Therefore, it is favorable for the third lens element to have a desired negative refractive power to increase the image surface area. Moreover, the following condition can also be satisfied: −2.50<f/f3<−0.50.

When a maximum field of view of the photographing optical lens system is FOV, the following condition can be satisfied: 125.0 degrees<FOV<175.0 degrees. Therefore, it is favorable for ensuring that the photographing optical lens system has a larger field of view for wider range of applications. Moreover, the following condition can also be satisfied: 128.0 degrees<FOV<172.0 degrees.

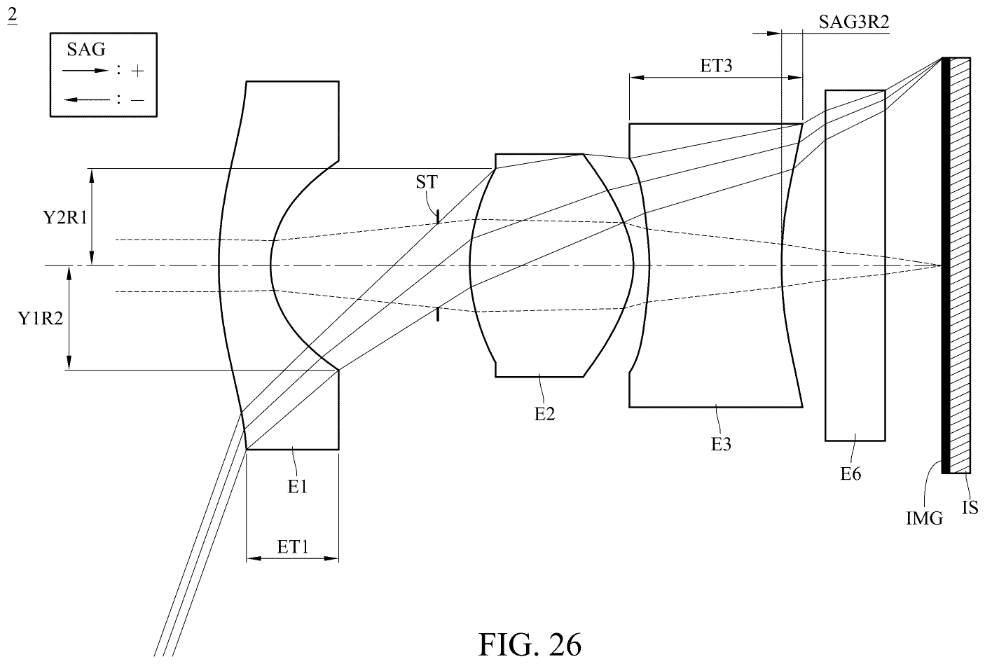

When a displacement in parallel with an optical axis from an axial vertex of the image-side surface of the third lens element to a maximum effective radius position of the image-side surface of the third lens element is SAG32, and the central thickness of the third lens element is CT3, the following condition can be satisfied: −0.30<SAG32/CT3<0.35. Therefore, it is favorable for regulating the variation degree of peripheral surface shape of the image-side surface of the third lens element to correct aberrations in the peripheral field of view. Moreover, the following condition can also be satisfied: −0.20<SAG32/CT3<0.30. Moreover, the following condition can also be satisfied: −0.15<SAG32/CT3<0.25. Please refer to FIG. 26, which shows a schematic view of SAG3R2 according to the 2nd embodiment of the present disclosure. When the direction from the axial vertex of one surface to the maximum effective radius position of the same surface is facing towards the image side of the photographing optical lens system, the value of displacement is positive; when the direction from the axial vertex of the surface to the maximum effective radius position of the same surface is facing towards the object side of the photographing optical lens system, the value of displacement is negative.

When the focal length of the photographing optical lens system is f, and the focal length of the first lens element is f1, the following condition can be satisfied: −1.50<f/f1<0.20. Therefore, it is favorable for adjusting the refractive power of the first lens element to obtain a balance between the expanded light-gathering range and the size of the photographing optical lens system. Moreover, the following condition can also be satisfied: −1.30<f/f1<0.00.

When the axial distance between the second lens element and the third lens element is T23, and the central thickness of the second lens element is CT2, the following condition can be satisfied: 0.03<T23/CT2<1.00. Therefore, it is favorable for effectively controlling the distance between the second lens element and the third lens element to control the total track length of the photographing optical lens system. Moreover, the following condition can also be satisfied: 0.05<T23/CT2<0.85.

When the focal length of the first lens element is f1, and a curvature radius of the image-side surface of the first lens element is R2, the following condition can be satisfied: −3.50<f1/R2<0.00. Therefore, by adjusting the shape and refractive power design of the first lens element, it is favorable for balancing the field of view and spherical aberration of the photographing optical lens system. Moreover, the following condition can also be satisfied: −3.00<f1/R2<−0.50. Moreover, the following condition can also be satisfied: −3.00<f1/R2<−1.20.

When a maximum effective radius of the image-side surface of the first lens element is Y1R2, and a maximum effective radius of the object-side surface of the second lens element is Y2R1, the following condition can be satisfied: 0.95<Y1R2/Y2R1<2.00. Therefore, it is favorable for improving the common issue of peripheral light dispersion in wide-angle lenses, and correcting off-axis aberrations. Please refer to FIG. 26, which shows a schematic view of Y1R2 and Y2R1 according to the 2nd embodiment of the present disclosure.

When a distance in parallel with the optical axis between a maximum effective radius position of the object-side surface of the first lens element and a maximum effective radius position of the image-side surface of the first lens element is ET1, and a distance in parallel with the optical axis between a maximum effective radius position of the object-side surface of the third lens element and the maximum effective radius position of the image-side surface of the third lens element is ET3, the following condition can be satisfied: 0.50<ET3/ET1<2.50. Therefore, it is favorable for adjusting the peripheral thicknesses of the first lens element and the third lens element to achieve a balance between the difficulty of lens shaping and the assembly yields of the lens elements. Moreover, the following condition can also be satisfied: 0.60<ET3/ET1<2.30. Please refer to FIG. 26, which shows a schematic view of ET1 and ET3 according to the 2nd embodiment of the present disclosure.

According to the present disclosure, the aforementioned features and conditions can be utilized in numerous combinations so as to achieve corresponding effects.

According to the present disclosure, the lens elements of the photographing optical lens system can be made of either glass or plastic material. When the lens elements are made of glass material, the refractive power distribution of the photographing optical lens system may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the photographing optical lens system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, focus or curvature radius of a lens element is not defined, it indicates that the region of refractive power, focus or curvature radius of the lens element is in the paraxial region thereof. In addition, a focal length of a single lens element is calculated based on the condition that the media in front of and behind the single lens element are both air.

According to the present disclosure, the image surface of the photographing optical lens system, based on the corresponding image sensor, can be flat or curved, especially a curved surface being concave facing towards the object side of the photographing optical lens system.

According to the present disclosure, an image correction unit, such as a field flattener, can be optionally disposed between the lens element closest to the image side of the photographing optical lens system along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

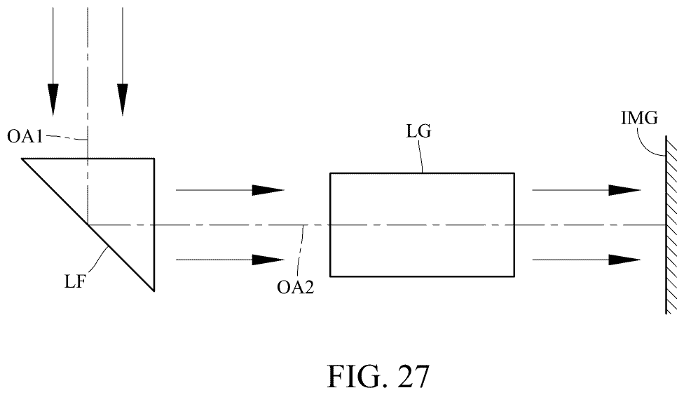

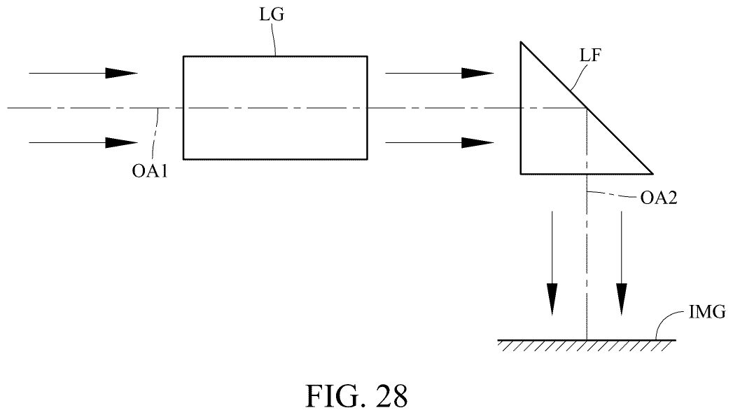

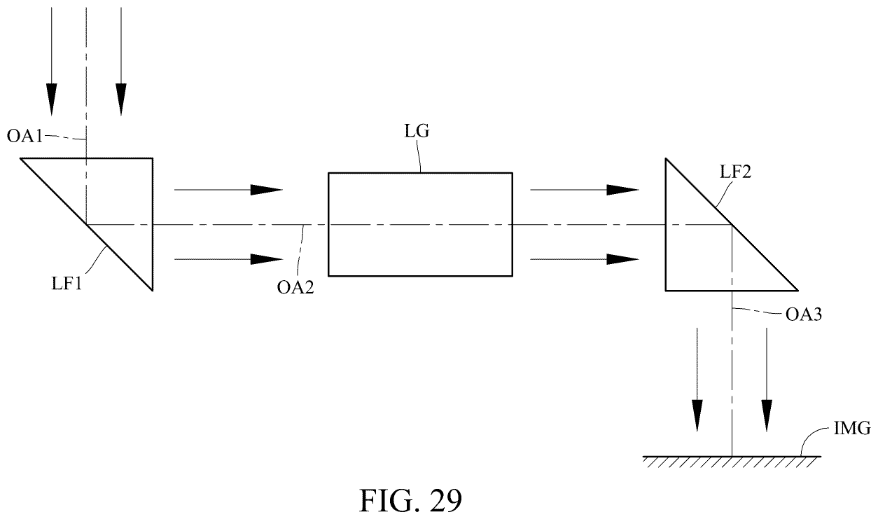

According to the present disclosure, at least one light-folding element, such as a prism or a mirror, can be optionally provided between an imaged object and the image surface on the imaging optical path, and the surface shape of the prism or mirror can be planar, spherical, aspheric or freeform surface, such that the photographing optical lens system can be more flexible in space arrangement, and therefore the dimensions of an electronic device is not restricted by the total track length of the photographing optical lens system. Specifically, please refer to FIG. 27 and FIG. 28. FIG. 27 shows a schematic view of a configuration of one light-folding element in a photographing optical lens system according to one embodiment of the present disclosure, and FIG. 28 shows a schematic view of another configuration of one light-folding element in a photographing optical lens system according to one embodiment of the present disclosure. In FIG. 27 and FIG. 28, the photographing optical lens system can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the photographing optical lens system as shown in FIG. 27, or disposed between a lens group LG and the image surface IMG of the photographing optical lens system as shown in FIG. 28. Furthermore, please refer to FIG. 29, which shows a schematic view of a configuration of two light-folding elements in a photographing optical lens system according to one embodiment of the present disclosure. In FIG. 29, the photographing optical lens system can have, in order from an imaged object (not shown in the figure) to an image surface IMG along an optical path, a first optical axis OA1, a first light-folding element LF1, a second optical axis OA2, a second light-folding element LF2 and a third optical axis OA3. The first light-folding element LF1 is disposed between the imaged object and a lens group LG of the photographing optical lens system, the second light-folding element LF2 is disposed between the lens group LG and the image surface IMG of the photographing optical lens system, and the travelling direction of light on the first optical axis OA1 can be the same direction as the travelling direction of light on the third optical axis OA3 as shown in FIG. 29. The photographing optical lens system can be optionally provided with three or more light-folding elements, and the present disclosure is not limited to the type, amount and position of the light-folding elements of the embodiments disclosed in the aforementioned figures.

According to the present disclosure, the photographing optical lens system can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the photographing optical lens system and the image surface to produce a telecentric effect, and thereby improves the image-sensing efficiency of an image sensor (for example, CCD or CMOS). A middle stop disposed between the first lens element and the image surface is favorable for enlarging the viewing angle of the photographing optical lens system and thereby provides a wider field of view for the same.

According to the present disclosure, the photographing optical lens system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the photographing optical lens system can include one or more optical elements for limiting the form of light passing through the photographing optical lens system. Each optical element can be, but not limited to, a filter, a polarizer, etc., and each optical element can be, but not limited to, a single-piece element, a composite component, a thin film, etc. The optical element can be located at the object side or the image side of the photographing optical lens system or between any two adjacent lens elements so as to allow light in a specific form to pass through, thereby meeting application requirements.

According to the present disclosure, the photographing optical lens system can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the object side and image side are defined in accordance with the direction of the optical axis, and the axial optical data are calculated along the optical axis. Furthermore, if the optical axis is deflected by a light-folding element, the axial optical data are also calculated along the deflected optical axis.

According to the above description of the present disclosure, the following specific embodiments are provided for further explanation.

### 1st Embodiment

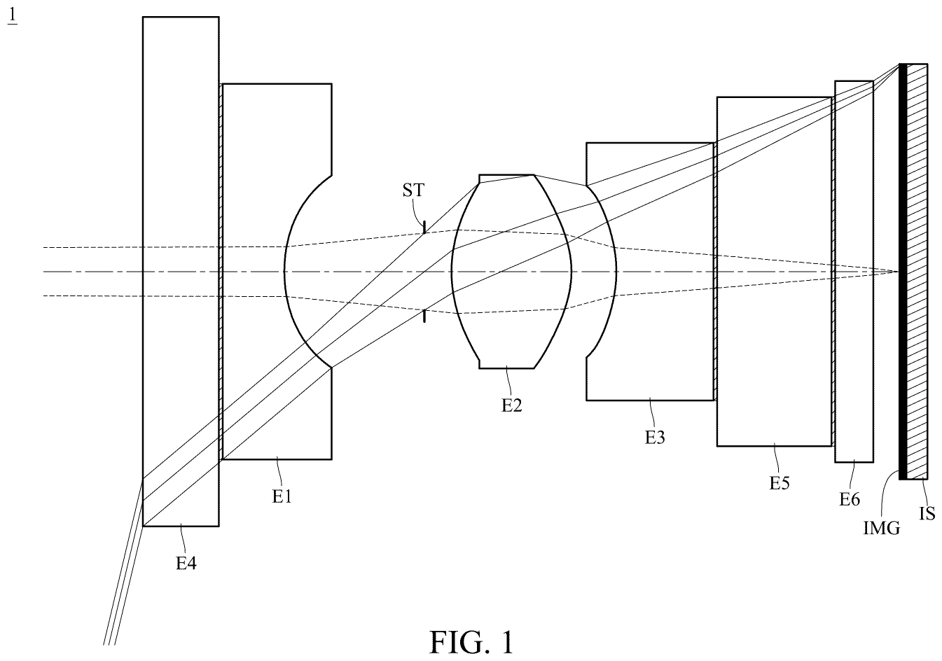

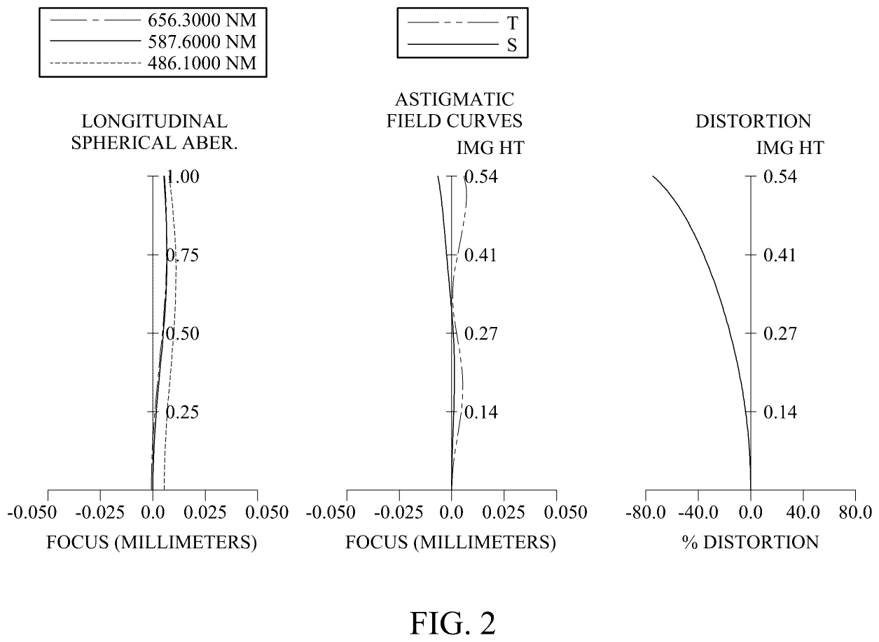

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the photographing optical lens system (its reference numeral is omitted) of the present disclosure and an image sensor IS. The photographing optical lens system includes, in order from an object side to an image side along an optical path, a first plate E4, a first lens element E1, an aperture stop ST, a second lens element E2, a third lens element E3, a second plate E5, a filter E6 and an image surface IMG. The photographing optical lens system includes three lens elements (E1, E2 and E3) with no additional lens element disposed between each of the adjacent three lens elements.

The first plate E4 is made of glass material and located between an imaged object and the first lens element E1, and will not affect the focal length of the photographing optical lens system.

The first lens element E1 with negative refractive power has an object-side surface being planar in a paraxial region thereof and an image-side surface being concave in a paraxial region thereof. The first lens element E1 is made of glass material and has the object-side surface being spherical and the image-side surface being aspheric. The object-side surface of the first lens element E1 is cemented to the first plate E4.

The second lens element E2 with positive refractive power has an object-side surface being convex in a paraxial region thereof and an image-side surface being convex in a paraxial region thereof. The second lens element E2 is made of glass material and has the object-side surface and the image-side surface being both aspheric.

The third lens element E3 with negative refractive power has an object-side surface being concave in a paraxial region thereof and an image-side surface being planar in a paraxial region thereof. The third lens element E3 is made of plastic material and has the object-side surface being aspheric and the image-side surface being spherical. The image-side surface of the third lens element E3 is cemented to the second plate E5.

The second plate E5 is made of glass material and located between the third lens element E3 and the image surface IMG, and will not affect the focal length of the photographing optical lens system.

The filter E6 is made of glass material and located between the second plate E5 and the image surface IMG, and will not affect the focal length of the photographing optical lens system. The filter E6 is cemented to the second plate E5. The image sensor IS is disposed on or near the image surface IMG of the photographing optical lens system.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12 and 14.

In the photographing optical lens system of the image capturing unit 1 according to the 1st embodiment, when a focal length of the photographing optical lens system is f, an f-number of the photographing optical lens system is Fno, and half of a maximum field of view of the photographing optical lens system is HFOV, these parameters have the following values: f=0.51 millimeters (mm), Fno=3.91, and HFOV=76.6 degrees (deg.).

When the maximum field of view of the photographing optical lens system is FOV, the following condition is satisfied: FOV=153.2 degrees.

When an axial distance between the object-side surface of the first lens element E1 and the image surface IMG is TL, and the focal length of the photographing optical lens system is f, the following condition is satisfied: TL/f=3.49.

When a maximum image height of the photographing optical lens system is ImgH, and the focal length of the photographing optical lens system is f, the following condition is satisfied: ImgH/f=1.06.

When an axial distance between the image-side surface of the third lens element E3 and the image surface IMG is BL, and an axial distance between the object-side surface of the first lens element E1 and the image-side surface of the third lens element E3 is TD, the following condition is satisfied: BL/TD=0.38.

When the focal length of the photographing optical lens system is f, and a focal length of the first lens element E1 is f1, the following condition is satisfied: f/f1=−0.70.

When the focal length of the photographing optical lens system is f, and a focal length of the third lens element E3 is f3, the following condition is satisfied: f/f3=−1.07.

When the focal length of the photographing optical lens system is f, and a composite focal length of the first lens element E1 and the second lens element E2 is f12, the following condition is satisfied: f/f12=1.99.

When the focal length of the photographing optical lens system is f, the focal length of the first lens element E1 is f1, a focal length of the second lens element E2 is f2, and the focal length of the third lens element E3 is f3, the following condition is satisfied: f/f1+f/f2+f/f3=−0.27.

When the focal length of the photographing optical lens system is f, a curvature radius of the object-side surface of the first lens element E1 is R1, and a curvature radius of the image-side surface of the third lens element E3 is R6, the following condition is satisfied: f/R1+f/R6=0.00.

When the focal length of the first lens element E1 is f1, and a curvature radius of the image-side surface of the first lens element E1 is R2, the following condition is satisfied: f1/R2=−1.96.

When a curvature radius of the image-side surface of the second lens element E2 is R4, and a curvature radius of the object-side surface of the third lens element E3 is R5, the following condition is satisfied: R5/R4=1.27.

When the curvature radius of the object-side surface of the third lens element E3 is R5, and the curvature radius of the image-side surface of the third lens element E3 is R6, the following condition is satisfied: R5/R6=0.00.

When a central thickness of the first lens element E1 is CT1, and a central thickness of the second lens element E2 is CT2, the following condition is satisfied:

$$CT 1 / CT 2 = 0.51 .$$

When the central thickness of the second lens element E2 is CT2, and a central thickness of the third lens element E3 is CT3, the following condition is satisfied: CT2/CT3=1.24.

When an axial distance between the first lens element E1 and the second lens element E2 is T12, and the central thickness of the first lens element E1 is CT1, the following condition is satisfied: T12/CT1=2.71. In this embodiment, an axial distance between two adjacent lens elements is a distance in a paraxial region between two adjacent lens surfaces of the two adjacent lens elements.

When an axial distance between the second lens element E2 and the third lens element E3 is T23, and the central thickness of the second lens element E2 is CT2, the following condition is satisfied: T23/CT2=0.37.

When the axial distance between the second lens element E2 and the third lens element E3 is T23, and the central thickness of the third lens element E3 is CT3, the following condition is satisfied: T23/CT3=0.46.

When the central thickness of the first lens element E1 is CT1, the central thickness of the second lens element E2 is CT2, and the central thickness of the third lens element E3 is CT3, the following condition is satisfied: (CT2+CT3)/CT1=3.52.

When a distance in parallel with the optical axis between a maximum effective radius position of the object-side surface of the first lens element E1 and a maximum effective radius position of the image-side surface of the first lens element E1 is ET1, and a distance in parallel with the optical axis between a maximum effective radius position of the object-side surface of the third lens element E3 and a maximum effective radius position of the image-side surface of the third lens element E3 is ET3, the following condition is satisfied: ET3/ET1=1.17.

When a maximum effective radius of the image-side surface of the first lens element E1 is Y1R2, and a maximum effective radius of the object-side surface of the second lens element E2 is Y2R1, the following condition is satisfied: Y1R2/Y2R1=1.08.

When a displacement in parallel with the optical axis from an axial vertex of the image-side surface of the third lens element E3 to the maximum effective radius position of the image-side surface of the third lens element E3 is SAG3R2, and the central thickness of the third lens element E3 is CT3, the following condition is satisfied: SAG3R2/CT3=0.00. In this embodiment, the image-side surface of the third lens element E3 is planar, so the displacement in parallel with the optical axis from the axial vertex to the maximum effective radius position of the image-side surface of the third lens element E3 is zero. Therefore, the value of SAG3R2 is zero.

The detailed optical data of the 1st embodiment are shown in Table 1A and the aspheric surface data are shown in Table 1B below.

TABLE 1A
1st Embodiment
f = 0.51 mm, Fno = 3.91, HFOV = 76.6 deg.

| Surface # | | Curvature Radius | | Thickness | Material | Index | Abbe # | Focal Length |
|---|---|---|---|---|---|---|---|---|
| 0 | Object | Infinity | | 15.000 | | | | |
| 1 | Plate 1 | Plano | | 0.200 | Glass | 1.517 | 64.2 | — |
| 2 | | Plano | | 0.010 | Cement | 1.485 | 53.2 | |
| 3 | Lens 1 | Plano | (SPH) | 0.162 | Glass | 1.510 | 63.4 | −0.73 |
| 4 | | 0.3735 | (ASP) | 0.368 | | | | |
| 5 | Ape. Stop | Plano | | 0.071 | | | | |
| 6 | Lens 2 | 0.3599 | (ASP) | 0.315 | Glass | 1.540 | 59.7 | 0.34 |
| 7 | | −0.2606 | (ASP) | 0.118 | | | | |
| 8 | Lens 3 | −0.3320 | (ASP) | 0.255 | Plastic | 1.697 | 16.3 | −0.48 |
| 9 | | Plano | (SPH) | 0.010 | Cement | 1.485 | 53.2 | |

| | | | | | | | |
|---|---|---|---|---|---|---|---|
| 10 | Plate 2 | Plano | 0.300 | Glass | 1.517 | 64.2 | — |
| 11 | | Plano | 0.010 | Cement | 1.485 | 53.2 | |
| 12 | Filter | Plano | 0.100 | Glass | 1.517 | 64.2 | — |
| 13 | | Plano | 0.069 | | | | |
| 14 | Image | Plano | — | | | | |

Note:
Reference wavelength is 587.6 nm (d-line).

TABLE 1B
Aspheric Coefficients

| Surface # | 4 | 6 | 7 | 8 |
|---|---|---|---|---|
| k= | −7.05045E−01 | −4.96304E−02 | −4.23889E−01 | −4.38008E−01 |
| A4= | 6.1294E+00 | −5.2848E+00 | 1.4995E+01 | 1.2919E+01 |
| A6= | 1.1900E+01 | 1.3276E+02 | −9.6878E+01 | −2.5127E+02 |
| A8= | 2.6931E+02 | −4.3633E+03 | 3.8553E+03 | 4.8031E+03 |
| A10= | 1.5664E+03 | 6.7543E+04 | −1.0682E+05 | −1.6958E+05 |
| A12= | 1.8653E+04 | −4.5985E+05 | 1.3028E+06 | 3.2969E+06 |
| A14= | — | — | −6.0425E+06 | −3.2058E+07 |

In Table 1A, the curvature radius, the thickness and the focal length are shown in millimeters (mm). Surface numbers 0-14 represent the surfaces sequentially arranged from the object side to the image side along the optical axis. In Table 1B, k represents the conic coefficient of the equation of the aspheric surface profiles. A4-A14 represent the aspheric coefficients ranging from the 4th order to the 14th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

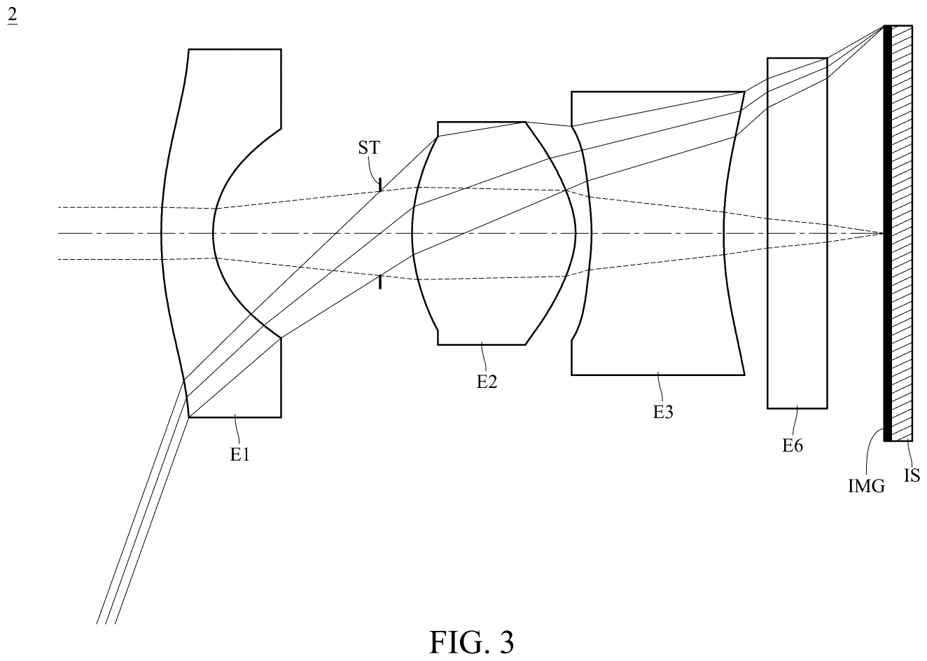

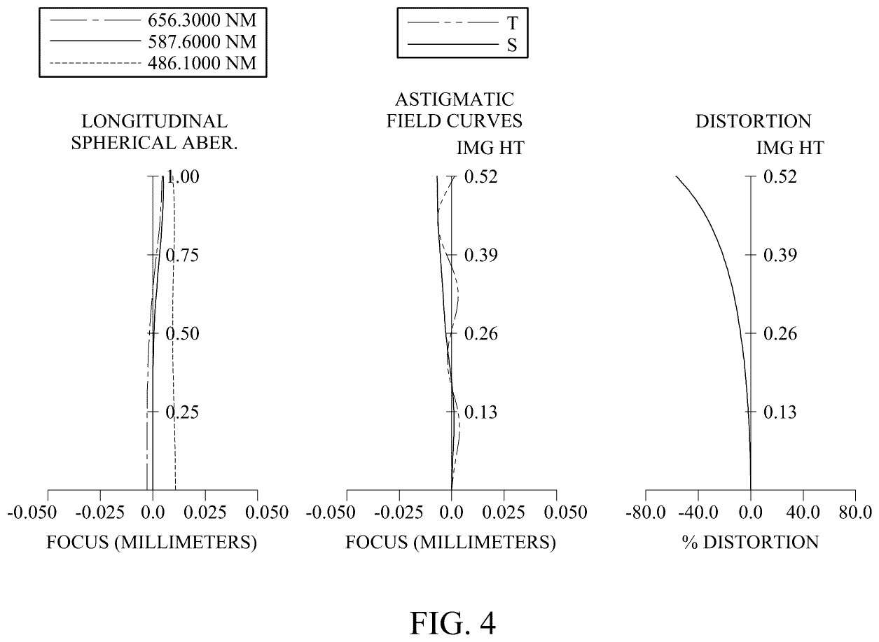

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the photographing optical lens system (its reference numeral is omitted) of the present disclosure and an image sensor IS. The photographing optical lens system includes, in order from an object side to an image side along an optical path, a first lens element E1, an aperture stop ST, a second lens element E2, a third lens element E3, a filter E6 and an image surface IMG. The photographing optical lens system includes three lens elements (E1, E2 and E3) with no additional lens element disposed between each of the adjacent three lens elements.

The first lens element E1 with negative refractive power has an object-side surface being convex in a paraxial region thereof and an image-side surface being concave in a paraxial region thereof. The first lens element E1 is made of plastic material and has the object-side surface and the image-side surface being both aspheric.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being concave in a paraxial region thereof. The third lens element E3 is made of plastic material and has the object-side surface and the image-side surface being both aspheric.

The filter E6 is made of glass material and located between the third lens element E3 and the image surface IMG, and will not affect the focal length of the photographing optical lens system. The image sensor IS is disposed on or near the image surface IMG of the photographing optical lens system.

The detailed optical data of the 2nd embodiment are shown in Table 2A and the aspheric surface data are shown in Table 2B below.

TABLE 2A
2nd Embodiment
f = 0.43 mm, Fno = 3.30, HFOV = 70.3 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 0.9615 | (ASP) | 0.130 | Plastic | 1.544 | 56.0 | −0.65 |
| 2 | | 0.2471 | (ASP) | 0.420 | | | | |
| 3 | Ape. Stop | Plano | | 0.080 | | | | |
| 4 | Lens 2 | 0.4380 | (ASP) | 0.411 | Plastic | 1.544 | 56.0 | 0.33 |
| 5 | | −0.2064 | (ASP) | 0.040 | | | | |
| 6 | Lens 3 | −0.5259 | (ASP) | 0.332 | Plastic | 1.697 | 16.3 | −0.45 |
| 7 | | 0.9650 | (ASP) | 0.110 | | | | |

| | | | | | | | |
|---|---|---|---|---|---|---|---|
| 8 | Filter | Plano | 0.150 | Glass | 1.517 | 64.2 | — |
| 9 | | Plano | 0.143 | | | | |
| 10 | Image | Plano | — | | | | |

Note:
Reference wavelength is 587.6 nm (d-line).

TABLE 2B
Aspheric Coefficients

| Surface # | 1 | 2 | 4 | 5 | 6 | 7 |
|---|---|---|---|---|---|---|
| k= | −7.57514E+00 | −7.91975E−01 | −1.00458E−01 | −8.14275E−01 | −1.96399E+00 | 5.15868E+00 |
| A4= | 9.2637E−01 | 6.7611E+00 | −3.6731E+00 | 3.8417E+01 | 3.0066E+01 | 1.4900E+00 |
| A6= | −1.1248E+01 | −7.9528E+01 | 4.1090E+01 | −9.1120E+02 | −9.7775E+02 | −3.0504E+01 |
| A8= | 2.8992E+01 | 2.3547E+03 | −8.7215E+02 | 1.5727E+04 | 1.8022E+04 | 1.5653E+02 |
| A10= | −2.1710E+01 | −3.8197E+04 | 1.2845E+04 | −1.6655E+05 | −2.1651E+05 | −2.4093E+02 |
| A12= | — | 2.0665E+05 | −6.3390E+04 | 9.5218E+05 | 1.3943E+06 | — |
| A14= | — | — | — | −1.9443E+06 | −3.5356E+06 | — |

In the 2nd embodiment, the equation of the aspheric surface profiles of the aforementioned lens elements is the same as the equation of the 1st embodiment. Also, the definitions of these parameters shown in Table 2C below are the same as those stated in the 1st embodiment with corresponding values for the 2nd embodiment, so an explanation in this regard will not be provided again. In this embodiment, the direction of SAG3R2 points toward the image side of the photographing optical lens system, and the value of SAG3R2 is positive.

Moreover, these parameters can be calculated from Table 2A and Table 2B as the following values and satisfy the following conditions:

TABLE 2C
Values of Optical and Physical Parameters/Definitions

| | | | |
|---|---|---|---|
| f [mm] | 0.43 | f1/R2 | −2.64 |
| Fno | 3.30 | R5/R4 | 2.55 |
| HFOV [deg.] | 70.3 | R5/R6 | −0.54 |
| FOV [deg.] | 140.6 | CT1/CT2 | 0.32 |
| TL/f | 4.20 | CT2/CT3 | 1.24 |
| ImgH/f | 1.20 | T12/CT1 | 3.85 |
| BL/TD | 0.29 | T23/CT2 | 0.10 |
| f/f1 | −0.66 | T23/CT3 | 0.12 |
| f/f3 | −0.97 | (CT2 + CT3)/CT1 | 5.72 |
| f/f12 | 2.04 | ET3/ET1 | 1.88 |
| f/f1 + f/f2 + f/f3 | −0.33 | Y1R2/Y2R1 | 1.08 |
| f/R1 + f/R6 | 0.90 | SAG3R2/CT3 | 0.16 |

### 3rd Embodiment

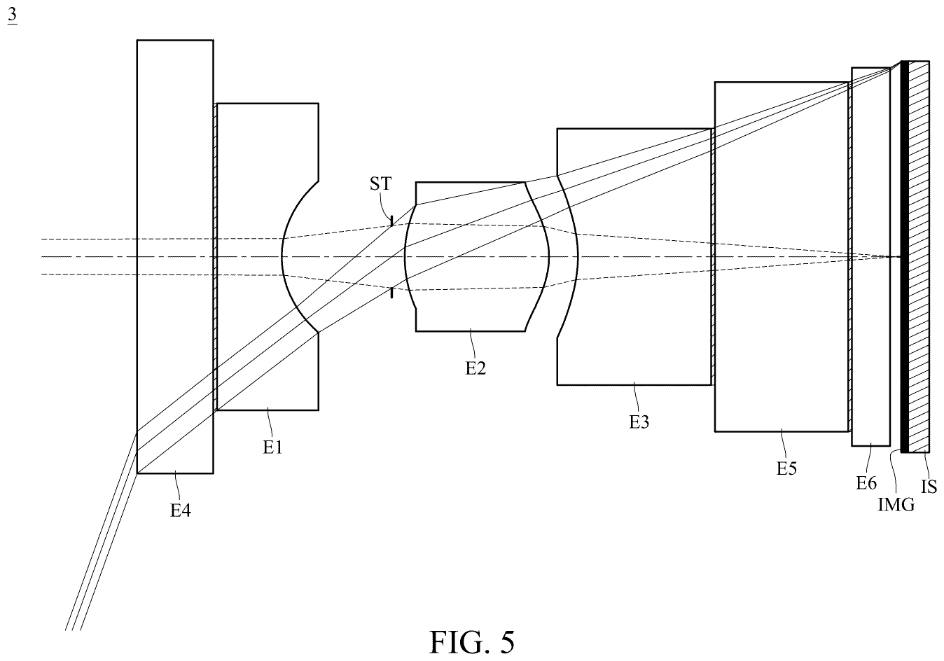

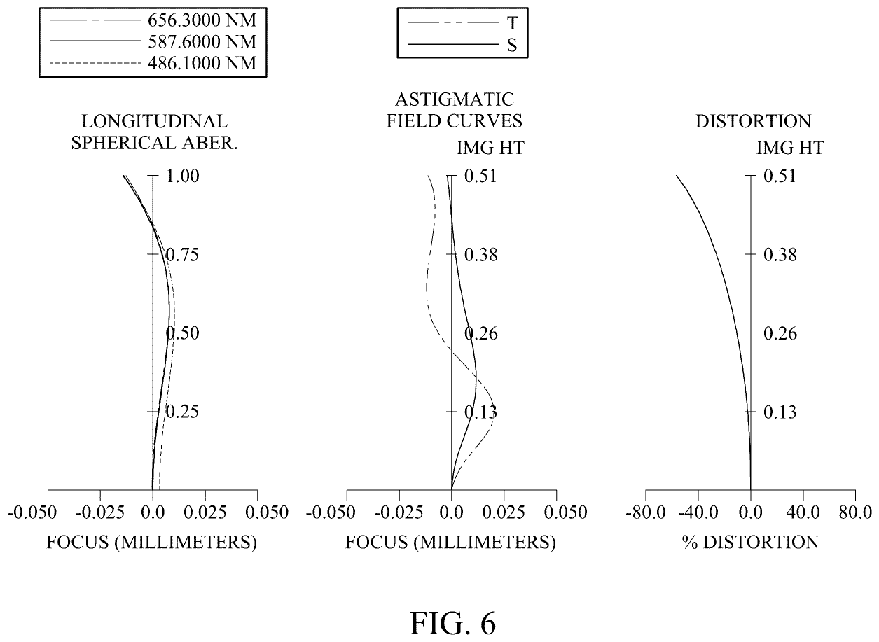

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the photographing optical lens system (its reference numeral is omitted) of the present disclosure and an image sensor IS. The photographing optical lens system includes, in order from an object side to an image side along an optical path, a first plate E4, a first lens element E1, an aperture stop ST, a second lens element E2, a third lens element E3, a second plate E5, a filter E6 and an image surface IMG. The photographing optical lens system includes three lens elements (E1, E2 and E3) with no additional lens element disposed between each of the adjacent three lens elements.

The first plate E4 is made of glass material and located between an imaged object and the first lens element E1, and will not affect the focal length of the photographing optical lens system.

The first lens element E1 with negative refractive power has an object-side surface being planar in a paraxial region thereof and an image-side surface being concave in a paraxial region thereof. The first lens element E1 is made of plastic material and has the object-side surface being spherical and the image-side surface being aspheric. The object-side surface of the first lens element E1 is cemented to the first plate E4.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being planar in a paraxial region thereof. The third lens element E3 is made of plastic material and has the object-side surface being aspheric and the image-side surface being spherical. The image-side surface of the third lens element E3 is cemented to the second plate E5.

The second plate E5 is made of glass material and located between the third lens element E3 and the image surface IMG, and will not affect the focal length of the photographing optical lens system.

The filter E6 is made of glass material and located between the second plate E5 and the image surface IMG, and will not affect the focal length of the photographing optical lens system. The filter E6 is cemented to the second plate E5. The image sensor IS is disposed on or near the image surface IMG of the photographing optical lens system.

The detailed optical data of the 3rd embodiment are shown in Table 3A and the aspheric surface data are shown in Table 3B below.

TABLE 3A
3rd Embodiment
f = 0.43 mm, Fno = 4.50, HFOV = 70.0 deg.

| Surface # | | Curvature Radius | | Thickness | Material | Index | Abbe # | Focal Length |
|---|---|---|---|---|---|---|---|---|
| 0 | Object | Infinity | | 10.000 | | | | |
| 1 | Plate 1 | Plano | | 0.200 | Glass | 1.517 | 64.2 | — |
| 2 | | Plano | | 0.010 | Cement | 1.485 | 53.2 | |
| 3 | Lens 1 | Plano | (SPH) | 0.170 | Plastic | 1.544 | 56.0 | −0.44 |
| 4 | | 0.2373 | (ASP) | 0.289 | | | | |
| 5 | Ape. Stop | Plano | | 0.034 | | | | |
| 6 | Lens 2 | 0.3226 | (ASP) | 0.379 | Plastic | 1.544 | 56.0 | 0.31 |
| 7 | | −0.2073 | (ASP) | 0.076 | | | | |
| 8 | Lens 3 | −0.3286 | (ASP) | 0.350 | Plastic | 1.669 | 19.5 | −0.49 |
| 9 | | Plano | (SPH) | 0.010 | Cement | 1.485 | 53.2 | |

| | | | | | | | |
|---|---|---|---|---|---|---|---|
| 10 | Plate 2 | Plano | 0.350 | Glass | 1.517 | 64.2 | — |
| 11 | | Plano | 0.010 | Cement | 1.485 | 53.2 | |
| 12 | Filter | Plano | 0.100 | Glass | 1.517 | 64.2 | — |
| 13 | | Plano | 0.030 | | | | |
| 14 | Image | Plano | — | | | | |

Note:
Reference wavelength is 587.6 nm (d-line).

TABLE 3B
Aspheric Coefficients

| Surface # | 4 | 6 | 7 | 8 |
|---|---|---|---|---|
| k= | −6.32549E−01 | 2.60452E−01 | −9.41753E−01 | −1.21753E+00 |
| A4= | 4.4116E+00 | −7.3700E+00 | 2.9376E+01 | 1.9184E+01 |
| A6= | −1.3969E+02 | 3.7635E+02 | −1.5092E+03 | −8.3091E+02 |
| A8= | 6.2760E+03 | −1.1972E+04 | 9.3481E+04 | 3.1285E+04 |
| A10= | −8.9412E+04 | 9.4671E+04 | −3.0289E+06 | −7.6347E+05 |
| A12= | 4.5632E+05 | 8.4413E+05 | 5.0900E+07 | 9.7148E+06 |
| A14= | — | — | −3.3019E+08 | −4.8835E+07 |

In the 3rd embodiment, the equation of the aspheric surface profiles of the aforementioned lens elements is the same as the equation of the 1st embodiment. Also, the definitions of these parameters shown in Table 3C below are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions:

TABLE 3C
Values of Optical and Physical Parameters/Definitions

| | | | |
|---|---|---|---|
| f [mm] | 0.43 | f1/R2 | −1.84 |
| Fno | 4.50 | R5/R4 | 1.59 |
| HFOV [deg.] | 70.0 | R5/R6 | 0.00 |
| FOV [deg.] | 140.0 | CT1/CT2 | 0.45 |
| TL/f | 4.17 | CT2/CT3 | 1.08 |
| ImgH/f | 1.19 | T12/CT1 | 1.90 |
| BL/TD | 0.39 | T23/CT2 | 0.20 |
| f/f1 | −0.99 | T23/CT3 | 0.22 |
| f/f3 | −0.88 | (CT2 + CT3)/CT1 | 4.29 |
| f/f12 | 2.07 | ET3/ET1 | 1.52 |
| f/f1 + f/f2 + f/f3 | −0.48 | Y1R2/Y2R1 | 1.46 |
| f/R1 + f/R6 | 0.00 | SAG3R2/CT3 | 0.00 |

### 4th Embodiment

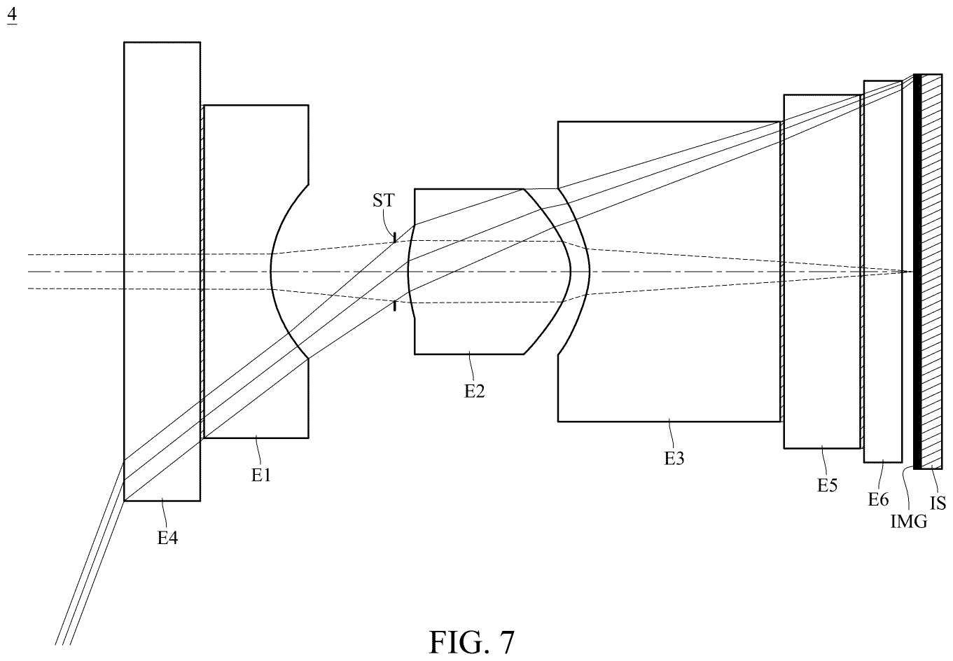

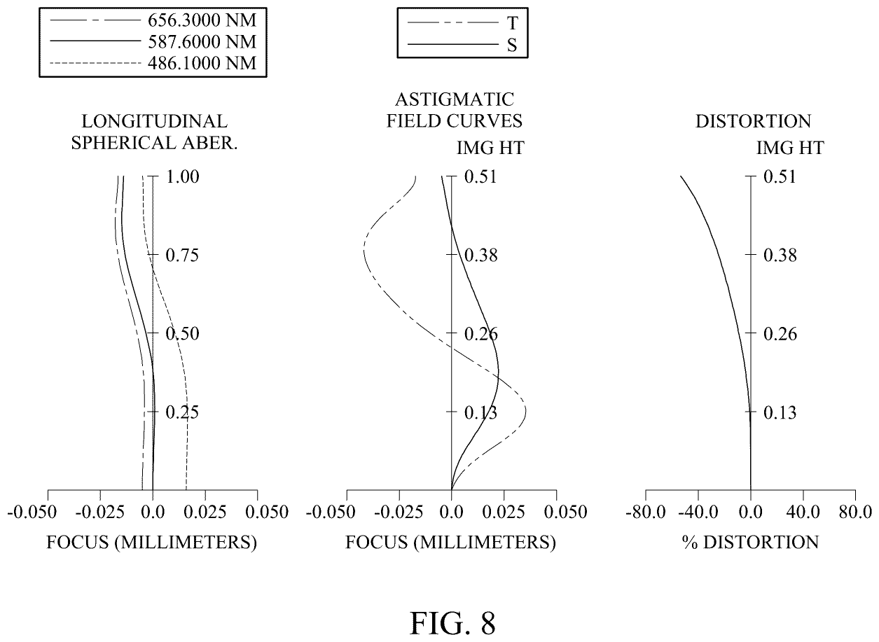

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the photographing optical lens system (its reference numeral is omitted) of the present disclosure and an image sensor IS. The photographing optical lens system includes, in order from an object side to an image side along an optical path, a first plate E4, a first lens element E1, an aperture stop ST, a second lens element E2, a third lens element E3, a second plate E5, a filter E6 and an image surface IMG. The photographing optical lens system includes three lens elements (E1, E2 and E3) with no additional lens element disposed between each of the adjacent three lens elements.

The first plate E4 is made of glass material and located between an imaged object and the first lens element E1, and will not affect the focal length of the photographing optical lens system.

The first lens element E1 with negative refractive power has an object-side surface being planar in a paraxial region thereof and an image-side surface being concave in a paraxial region thereof. The first lens element E1 is made of plastic material and has the object-side surface being spherical and the image-side surface being aspheric. The object-side surface of the first lens element E1 is cemented to the first plate E4.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being planar in a paraxial region thereof. The third lens element E3 is made of plastic material and has the object-side surface being aspheric and the image-side surface being spherical. The image-side surface of the third lens element E3 is cemented to the second plate E5.

The second plate E5 is made of glass material and located between the third lens element E3 and the image surface IMG, and will not affect the focal length of the photographing optical lens system.

The filter E6 is made of glass material and located between the second plate E5 and the image surface IMG, and will not affect the focal length of the photographing optical lens system. The filter E6 is cemented to the second plate E5. The image sensor IS is disposed on or near the image surface IMG of the photographing optical lens system.

The detailed optical data of the 4th embodiment are shown in Table 4A and the aspheric surface data are shown in Table 4B below.

TABLE 4A
4th Embodiment
f = 0.42 mm, Fno = 4.50, HFOV = 69.4 deg.

| Surface # | | Curvature Radius | | Thickness | Material | Index | Abbe # | Focal Length |
|---|---|---|---|---|---|---|---|---|
| 0 | Object | Infinity | | 10.000 | | | | |
| 1 | Plate 1 | Plano | | 0.200 | Glass | 1.517 | 64.2 | — |
| 2 | | Plano | | 0.010 | Cement | 1.485 | 53.2 | |
| 3 | Lens 1 | Plano | (SPH) | 0.175 | Plastic | 1.544 | 56.0 | −0.51 |
| 4 | | 0.2757 | (ASP) | 0.326 | | | | |
| 5 | Ape. Stop | Plano | | 0.035 | | | | |
| 6 | Lens 2 | 0.4061 | (ASP) | 0.427 | Plastic | 1.544 | 56.0 | 0.25 |
| 7 | | −0.1326 | (ASP) | 0.050 | | | | |
| 8 | Lens 3 | −0.1860 | (ASP) | 0.501 | Plastic | 1.671 | 19.5 | −0.28 |
| 9 | | Plano | (SPH) | 0.010 | Cement | 1.485 | 53.2 | |

| | | | | | | | |
|---|---|---|---|---|---|---|---|
| 10 | Plate 2 | Plano | 0.200 | Glass | 1.517 | 64.2 | — |
| 11 | | Plano | 0.010 | Cement | 1.485 | 53.2 | |
| 12 | Filter | Plano | 0.100 | Glass | 1.517 | 64.2 | — |
| 13 | | Plano | 0.032 | | | | |
| 14 | Image | Plano | — | | | | |

Note:
Reference wavelength is 587.6 nm (d-line).

TABLE 4B
Aspheric Coefficients

| Surface # | 4 | 6 | 7 | 8 |
|---|---|---|---|---|
| k= | −6.86815E−01 | 7.35893E+00 | −1.12501E+00 | −4.16719E+00 |
| A4= | −6.0694E+00 | −2.1606E+01 | 7.2746E+01 | 2.1846E+01 |
| A6= | 4.8466E+02 | 2.8492E+03 | −3.5425E+03 | −1.5387E+03 |
| A8= | −1.7097E+04 | −7.0132E+05 | 1.0921E+05 | 4.7456E+04 |
| A10= | 2.6259E+05 | 5.2793E+07 | −1.7392E+06 | −7.7683E+05 |
| A12= | −1.4091E+06 | −1.4704E+09 | 1.0667E+07 | 4.9287E+06 |

In the 4th embodiment, the equation of the aspheric surface profiles of the aforementioned lens elements is the same as the equation of the 1st embodiment. Also, the definitions of these parameters shown in Table 4C below are the same as those stated in the 1st embodiment with corresponding values for the 4th embodiment, so an explanation in this regard will not be provided again. Moreover, these parameters can be calculated from Table 4A and Table 4B as the following values and satisfy the following conditions:

TABLE 4C
Values of Optical and Physical Parameters/Definitions

| | | | |
|---|---|---|---|
| f [mm] | 0.42 | f1/R2 | −1.84 |
| Fno | 4.50 | R5/R4 | 1.40 |
| HFOV [deg.] | 69.4 | R5/R6 | 0.00 |
| FOV [deg.] | 138.8 | CT1/CT2 | 0.41 |
| TL/f | 4.45 | CT2/CT3 | 0.85 |
| ImgH/f | 1.22 | T12/CT1 | 2.06 |
| BL/TD | 0.23 | T23/CT2 | 0.12 |
| f/f1 | −0.83 | T23/CT3 | 0.10 |
| f/f3 | −1.51 | (CT2 + CT3)/CT1 | 5.30 |
| f/f12 | 2.93 | ET3/ET1 | 2.13 |
| f/f1 + f/f2 + f/f3 | −0.69 | Y1R2/Y2R1 | 1.86 |
| f/R1 + f/R6 | 0.00 | SAG3R2/CT3 | 0.00 |

### 5th Embodiment

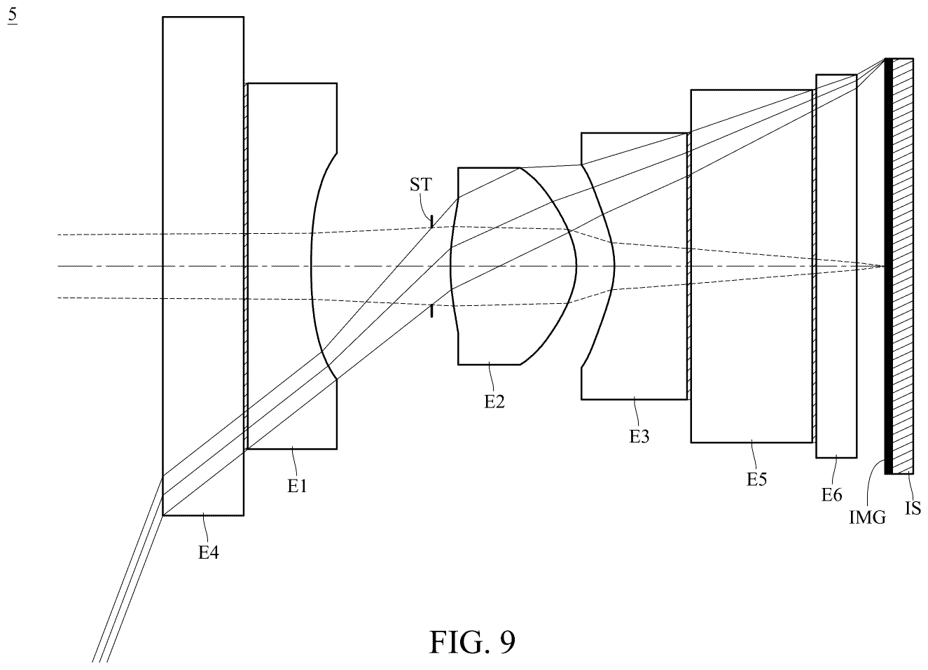

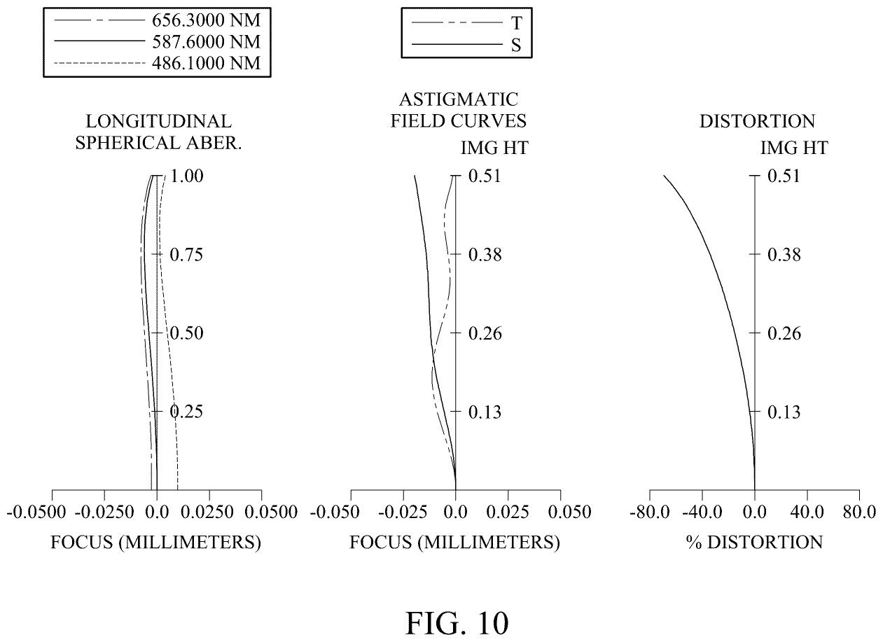

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the photographing optical lens system (its reference numeral is omitted) of the present disclosure and an image sensor IS. The photographing optical lens system includes, in order from an object side to an image side along an optical path, a first plate E4, a first lens element E1, an aperture stop ST, a second lens element E2, a third lens element E3, a second plate E5, a filter E6 and an image surface IMG. The photographing optical lens system includes three lens elements (E1, E2 and E3) with no additional lens element disposed between each of the adjacent three lens elements.

The first plate E4 is made of glass material and located between an imaged object and the first lens element E1, and will not affect the focal length of the photographing optical lens system.

The first lens element E1 with negative refractive power has an object-side surface being planar in a paraxial region thereof and an image-side surface being concave in a paraxial region thereof. The first lens element E1 is made of glass material and has the object-side surface being spherical and the image-side surface being aspheric. The object-side surface of the first lens element E1 is cemented to the first plate E4.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being planar in a paraxial region thereof. The third lens element E3 is made of plastic material and has the object-side surface being aspheric and the image-side surface being spherical. The image-side surface of the third lens element E3 is cemented to the second plate E5.

The second plate E5 is made of glass material and located between the third lens element E3 and the image surface IMG, and will not affect the focal length of the photographing optical lens system.

The filter E6 is made of glass material and located between the second plate E5 and the image surface IMG, and will not affect the focal length of the photographing optical lens system. The filter E6 is cemented to the second plate E5. The image sensor IS is disposed on or near the image surface IMG of the photographing optical lens system.

The detailed optical data of the 5th embodiment are shown in Table 5A and the aspheric surface data are shown in Table 5B below.

TABLE 5A
5th Embodiment
f = 0.63 mm, Fno = 4.00, HFOV = 68.7 deg.

| Surface # | | Curvature Radius | | Thickness | Material | Index | Abbe # | Focal Length |
|---|---|---|---|---|---|---|---|---|
| 0 | Object | Infinity | | 10.000 | | | | |
| 1 | Plate 1 | Plano | | 0.200 | Glass | 1.517 | 64.2 | — |
| 2 | | Plano | | 0.010 | Cement | 1.485 | 53.2 | |
| 3 | Lens 1 | Plano | (SPH) | 0.157 | Glass | 1.516 | 56.8 | −2.47 |
| 4 | | 1.2750 | (ASP) | 0.299 | | | | |
| 5 | Ape. Stop | Plano | | 0.046 | | | | |
| 6 | Lens 2 | 0.5619 | (ASP) | 0.312 | Plastic | 1.544 | 56.0 | 0.30 |
| 7 | | −0.1868 | (ASP) | 0.094 | | | | |
| 8 | Lens 3 | −0.2268 | (ASP) | 0.180 | Plastic | 1.697 | 16.3 | −0.33 |
| 9 | | Plano | (SPH) | 0.010 | Cement | 1.485 | 53.2 | |

| | | | | | | | |
|---|---|---|---|---|---|---|---|
| 10 | Plate 2 | Plano | 0.300 | Glass | 1.517 | 64.2 | — |
| 11 | | Plano | 0.010 | Cement | 1.485 | 53.2 | |
| 12 | Filter | Plano | 0.100 | Glass | 1.517 | 64.2 | — |
| 13 | | Plano | 0.073 | | | | |
| 14 | Image | Plano | — | | | | |

Note:
Reference wavelength is 587.6 nm (d-line).

TABLE 5B
Aspheric Coefficients

| Surface # | 4 | 6 | 7 | 8 |
|---|---|---|---|---|
| k= | −4.34847E+01 | −2.78062E+00 | −7.10854E−01 | −2.42587E+00 |
| A4= | 8.1138E+00 | −4.4590E+00 | 2.3166E+01 | 2.5116E+01 |
| A6= | −5.7793E+01 | −8.3352E+00 | 1.5474E+01 | −6.3188E+02 |
| A8= | 6.9810E+02 | 3.3433E+03 | −5.7464E+03 | 1.1730E+04 |
| A10= | −4.3878E+03 | −2.7896E+05 | 7.1681E+04 | −1.6923E+05 |
| A12= | 2.4750E+04 | 3.3735E+06 | −3.2549E+05 | 1.3447E+06 |
| A14= | — | — | −2.0323E+06 | −4.8707E+06 |

In the 5th embodiment, the equation of the aspheric surface profiles of the aforementioned lens elements is the same as the equation of the 1st embodiment. Also, the definitions of these parameters shown in Table 5C below are the same as those stated in the 1st embodiment with corresponding values for the 5th embodiment, so an explanation in this regard will not be provided again.

Moreover, these parameters can be calculated from Table 5A and Table 5B as the following values and satisfy the following conditions:

TABLE 5C
Values of Optical and Physical Parameters/Definitions

| | | | |
|---|---|---|---|
| f [mm] | 0.63 | f1/R2 | −1.94 |
| Fno | 4.00 | R5/R4 | 1.21 |
| HFOV [deg.] | 68.7 | R5/R6 | 0.00 |
| FOV [deg.] | 137.4 | CT1/CT2 | 0.50 |
| TL/f | 2.50 | CT2/CT3 | 1.73 |
| ImgH/f | 0.81 | T12/CT1 | 2.20 |
| BL/TD | 0.45 | T23/CT2 | 0.30 |
| f/f1 | −0.26 | T23/CT3 | 0.52 |
| f/f3 | −1.95 | (CT2 + CT3)/CT1 | 3.13 |
| f/f12 | 2.28 | ET3/ET1 | 1.18 |
| f/f1 + f/f2 + f/f3 | −0.11 | Y1R2/Y2R1 | 1.65 |
| f/R1 + f/R6 | 0.00 | SAG3R2/CT3 | 0.00 |

### 6th Embodiment

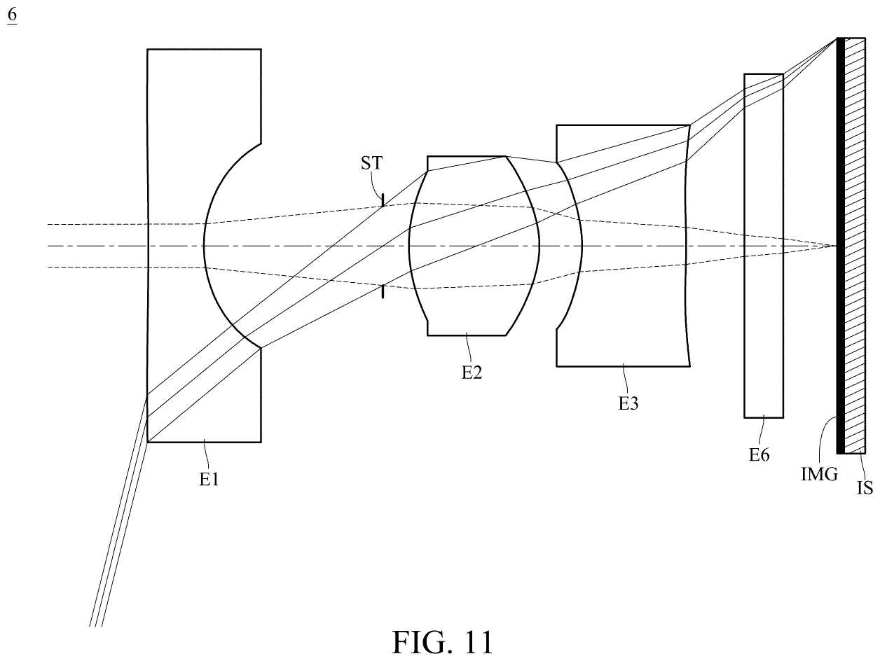

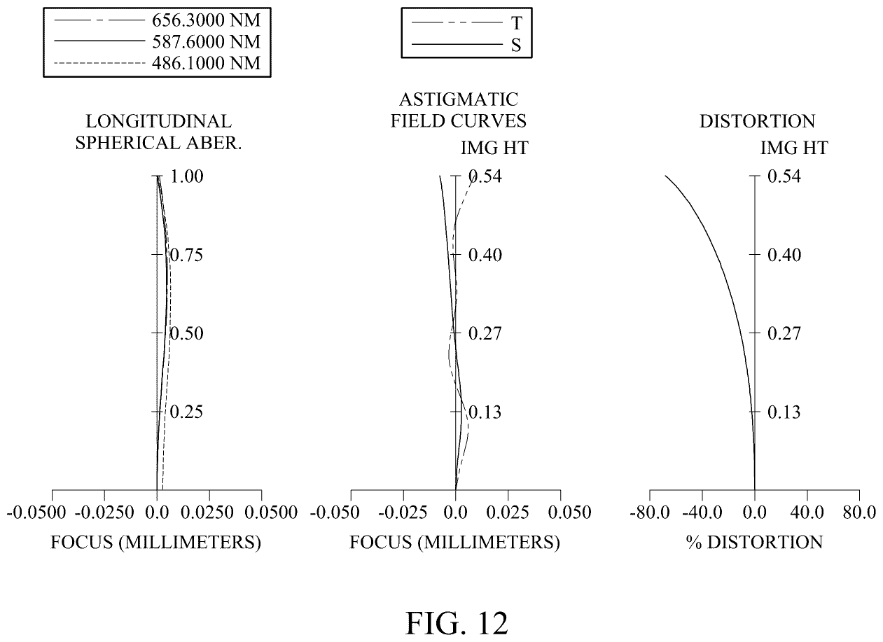

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the photographing optical lens system (its reference numeral is omitted) of the present disclosure and an image sensor IS. The photographing optical lens system includes, in order from an object side to an image side along an optical path, a first lens element E1, an aperture stop ST, a second lens element E2, a third lens element E3, a filter E6 and an image surface IMG. The photographing optical lens system includes three lens elements (E1, E2 and E3) with no additional lens element disposed between each of the adjacent three lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being convex in a paraxial region thereof. The third lens element E3 is made of plastic material and has the object-side surface and the image-side surface being both aspheric.

The filter E6 is made of glass material and located between the third lens element E3 and the image surface IMG, and will not affect the focal length of the photographing optical lens system. The image sensor IS is disposed on or near the image surface IMG of the photographing optical lens system.

The detailed optical data of the 6th embodiment are shown in Table 6A and the aspheric surface data are shown in Table 6B below.

TABLE 6A
6th Embodiment
f = 0.42 mm, Fno = 3.70, HFOV = 76.0 deg.

| Surface # | | Curvature Radius | | Thickness | Material | Index | Abbe # | Focal Length |
|---|---|---|---|---|---|---|---|---|
| 0 | Object | Infinity | | 20.000 | | | | |
| 1 | Lens 1 | −9.8213 | (ASP) | 0.143 | Plastic | 1.534 | 56.0 | −0.60 |
| 2 | | 0.3323 | (ASP) | 0.461 | | | | |
| 3 | Ape. Stop | Plano | | 0.067 | | | | |
| 4 | Lens 2 | 0.3699 | (ASP) | 0.336 | Plastic | 1.544 | 56.0 | 0.34 |
| 5 | | −0.2527 | (ASP) | 0.110 | | | | |
| 6 | Lens 3 | −0.2998 | (ASP) | 0.268 | Plastic | 1.697 | 16.3 | −0.59 |
| 7 | | −1.4846 | (ASP) | 0.150 | | | | |

| | | | | | | | |
|---|---|---|---|---|---|---|---|
| 8 | Filter | Plano | 0.100 | Glass | 1.517 | 64.2 | — |
| 9 | | Plano | 0.139 | | | | |
| 10 | Image | Plano | — | | | | |

Note:
Reference wavelength is 587.6 nm (d-line).

TABLE 6B
Aspheric Coefficients

| Surface # | 1 | 2 | 4 | 5 | 6 | 7 |
|---|---|---|---|---|---|---|
| k= | −9.63042E+01 | −9.58655E−01 | −9.58098E−01 | −7.90378E−01 | −1.68259E+00 | −9.90000E+01 |
| A4= | 1.2710E−02 | 5.4523E+00 | −3.0031E+00 | 1.8239E+01 | 2.8640E+01 | 1.0470E+01 |
| A6= | 4.6288E+00 | −9.4771E+01 | 1.3682E+02 | −3.3965E+02 | −1.0912E+03 | −1.6071E+02 |
| A8= | −4.1264E+01 | 4.8188E+03 | −5.9345E+03 | 6.7962E+03 | 2.6059E+04 | 1.5396E+03 |
| A10= | 1.6620E+02 | −6.9616E+04 | 1.2632E+05 | −1.2800E+05 | −5.2687E+05 | −1.0780E+04 |
| A12= | −3.3066E+02 | 4.2731E+05 | −1.1960E+06 | 1.4186E+06 | 6.3876E+06 | 5.2523E+04 |
| A14= | 2.6418E+02 | — | — | −7.2986E+06 | −3.9565E+07 | −1.2334E+05 |

In the 6th embodiment, the equation of the aspheric surface profiles of the aforementioned lens elements is the same as the equation of the 1st embodiment. Also, the definitions of these parameters shown in Table 6C below are the same as those stated in the 1st embodiment with corresponding values for the 6th embodiment, so an explanation in this regard will not be provided again.

Moreover, these parameters can be calculated from Table 6A and Table 6B as the following values and satisfy the following conditions:

TABLE 6C
Values of Optical and Physical Parameters/Definitions

| | | | |
|---|---|---|---|
| f [mm] | 0.42 | f1/R2 | −1.80 |
| Fno | 3.70 | R5/R4 | 1.19 |
| HFOV [deg.] | 76.0 | R5/R6 | 0.20 |
| FOV [deg.] | 152.0 | CT1/CT2 | 0.43 |
| TL/f | 4.25 | CT2/CT3 | 1.25 |
| ImgH/f | 1.28 | T12/CT1 | 3.69 |
| BL/TD | 0.28 | T23/CT2 | 0.33 |
| f/f1 | −0.70 | T23/CT3 | 0.41 |
| f/f3 | −0.70 | (CT2 + CT3)/CT1 | 4.22 |
| f/f12 | 1.94 | ET3/ET1 | 1.17 |
| f/f1 + f/f2 + f/f3 | −0.18 | Y1R2/Y2R1 | 1.37 |
| f/R1 + f/R6 | −0.32 | SAG3R2/CT3 | 0.04 |

### 7th Embodiment

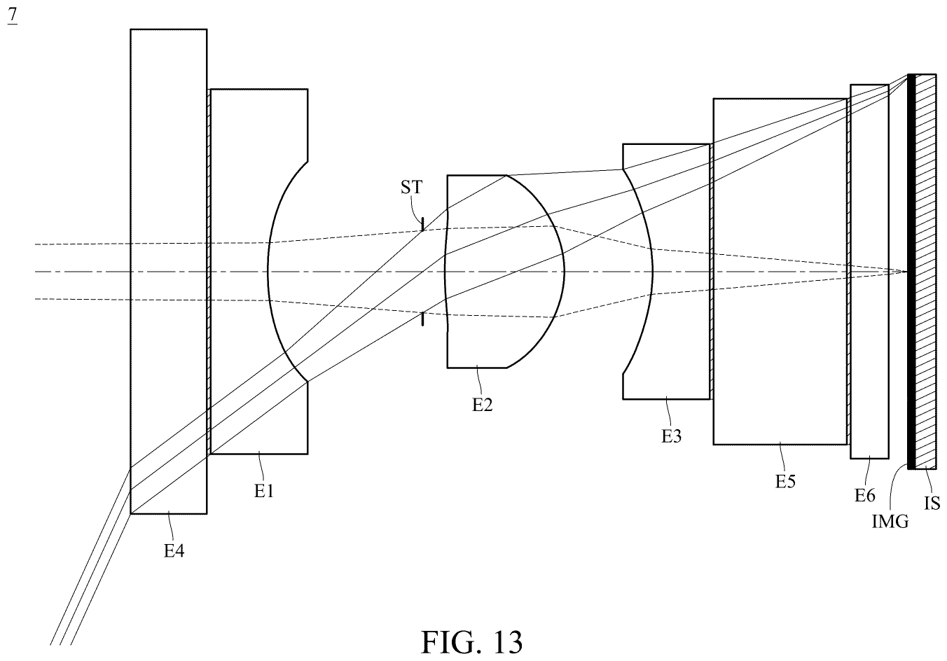

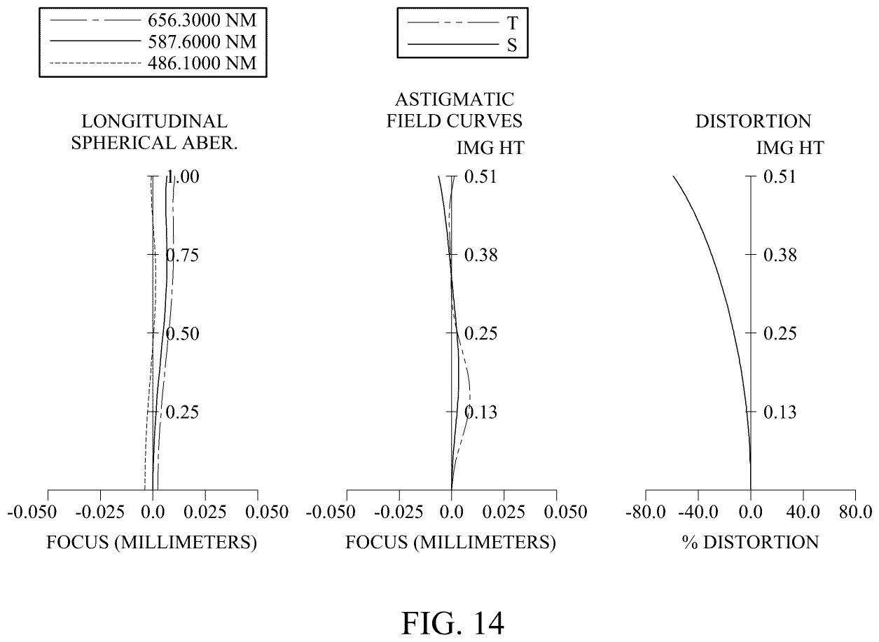

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the photographing optical lens system (its reference numeral is omitted) of the present disclosure and an image sensor IS. The photographing optical lens system includes, in order from an object side to an image side along an optical path, a first plate E4, a first lens element E1, an aperture stop ST, a second lens element E2, a third lens element E3, a second plate E5, a filter E6 and an image surface IMG. The photographing optical lens system includes three lens elements (E1, E2 and E3) with no additional lens element disposed between each of the adjacent three lens elements.

The first plate E4 is made of glass material and located between an imaged object and the first lens element E1, and will not affect the focal length of the photographing optical lens system.

The first lens element E1 with negative refractive power has an object-side surface being planar in a paraxial region thereof and an image-side surface being concave in a paraxial region thereof. The first lens element E1 is made of glass material and has the object-side surface being spherical and the image-side surface being aspheric. The object-side surface of the first lens element E1 is cemented to the first plate E4.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being planar in a paraxial region thereof. The third lens element E3 is made of plastic material and has the object-side surface being aspheric and the image-side surface being spherical. The image-side surface of the third lens element E3 is cemented to the second plate E5.

The second plate E5 is made of glass material and located between the third lens element E3 and the image surface IMG, and will not affect the focal length of the photographing optical lens system.

The filter E6 is made of glass material and located between the second plate E5 and the image surface IMG, and will not affect the focal length of the photographing optical lens system. The filter E6 is cemented to the second plate E5. The image sensor IS is disposed on or near the image surface IMG of the photographing optical lens system.

The detailed optical data of the 7th embodiment are shown in Table 7A and the aspheric surface data are shown in Table 7B below.

TABLE 7A
7th Embodiment
f = 0.57 mm, Fno = 3.80, HFOV = 65.1 deg.

| Surface # | | Curvature Radius | | Thickness | Material | Index | Abbe # | Focal Length |
|---|---|---|---|---|---|---|---|---|
| 0 | Object | Infinity | | 8.000 | | | | |
| 1 | Plate 1 | Plano | | 0.200 | Glass | 1.517 | 64.2 | — |
| 2 | | Plano | | 0.010 | Cement | 1.485 | 53.2 | |
| 3 | Lens 1 | Plano | (SPH) | 0.150 | Glass | 1.523 | 58.7 | −1.13 |
| 4 | | 0.5910 | (ASP) | 0.407 | | | | |
| 5 | Ape. Stop | Plano | | 0.058 | | | | |
| 6 | Lens 2 | 0.8333 | (ASP) | 0.314 | Plastic | 1.544 | 56.0 | 0.41 |
| 7 | | −0.2617 | (ASP) | 0.232 | | | | |
| 8 | Lens 3 | −0.4206 | (ASP) | 0.150 | Plastic | 1.697 | 16.3 | −0.60 |
| 9 | | Plano | (SPH) | 0.010 | Cement | 1.485 | 53.2 | |

| | | | | | | | |
|---|---|---|---|---|---|---|---|
| 10 | Plate 2 | Plano | 0.350 | Glass | 1.517 | 64.2 | — |
| 11 | | Plano | 0.010 | Cement | 1.485 | 53.2 | |
| 12 | Filter | Plano | 0.100 | Glass | 1.517 | 64.2 | — |
| 13 | | Plano | 0.053 | | | | |
| 14 | Image | Plano | — | | | | |

Note:
Reference wavelength is 587.6 nm (d-line).

TABLE 7B
Aspheric Coefficients

| Surface # | 4 | 6 | 7 | 8 |
|---|---|---|---|---|
| k= | −1.58782E+00 | −1.93960E+01 | −7.06250E−01 | −7.64577E−01 |
| A4= | 4.2164E+00 | −4.1738E+00 | 2.5891E+00 | 5.5955E+00 |
| A6= | −9.5912E+00 | −1.7613E+02 | −1.5805E+02 | −1.7461E+01 |
| A8= | 4.3799E+02 | 6.4760E+03 | 6.6280E+03 | −1.9922E+03 |
| A10= | −4.2422E+03 | −2.4204E+05 | −2.0582E+05 | 5.3439E+04 |
| A12= | 2.3634E+04 | −1.6068E+06 | 2.9197E+06 | −6.7418E+05 |
| A14= | — | — | −1.7948E+07 | 3.1593E+06 |

In the 7th embodiment, the equation of the aspheric surface profiles of the aforementioned lens elements is the same as the equation of the 1st embodiment. Also, the definitions of these parameters shown in Table 7C below are the same as those stated in the 1st embodiment with corresponding values for the 7th embodiment, so an explanation in this regard will not be provided again.

Moreover, these parameters can be calculated from Table 7A and Table 7B as the following values and satisfy the following conditions:

TABLE 8C
Values of Optical and Physical Parameters/Definitions

| | | | |
|---|---|---|---|
| f [mm] | 0.57 | f1/R2 | −1.91 |
| Fno | 3.80 | R5/R4 | 1.61 |
| HFOV [deg.] | 65.1 | R5/R6 | 0.00 |
| FOV [deg.] | 130.2 | CT1/CT2 | 0.48 |
| TL/f | 3.24 | CT2/CT3 | 2.09 |
| ImgH/f | 0.90 | T12/CT1 | 3.10 |
| BL/TD | 0.40 | T23/CT2 | 0.74 |
| f/f1 | −0.50 | T23/CT3 | 1.55 |
| f/f3 | −0.94 | (CT2 + CT3)/CT1 | 3.09 |
| f/f12 | 1.67 | ET3/ET1 | 0.89 |
| f/f1 + f/f2 + f/f3 | −0.05 | Y1R2/Y2R1 | 1.75 |
| f/R1 + f/R6 | 0.00 | SAG3R2/CT3 | 0.00 |

### 8th Embodiment

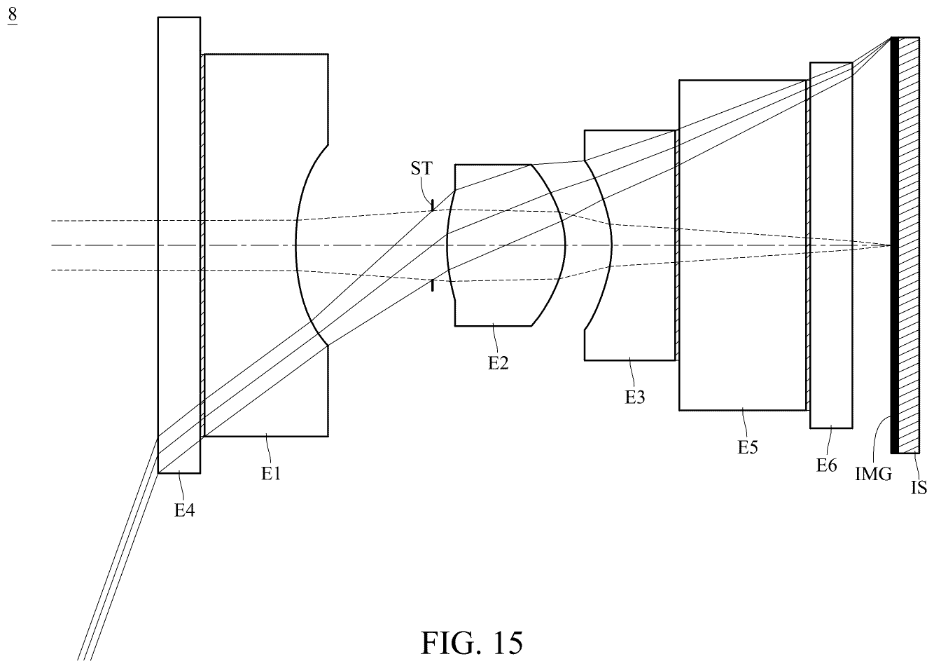

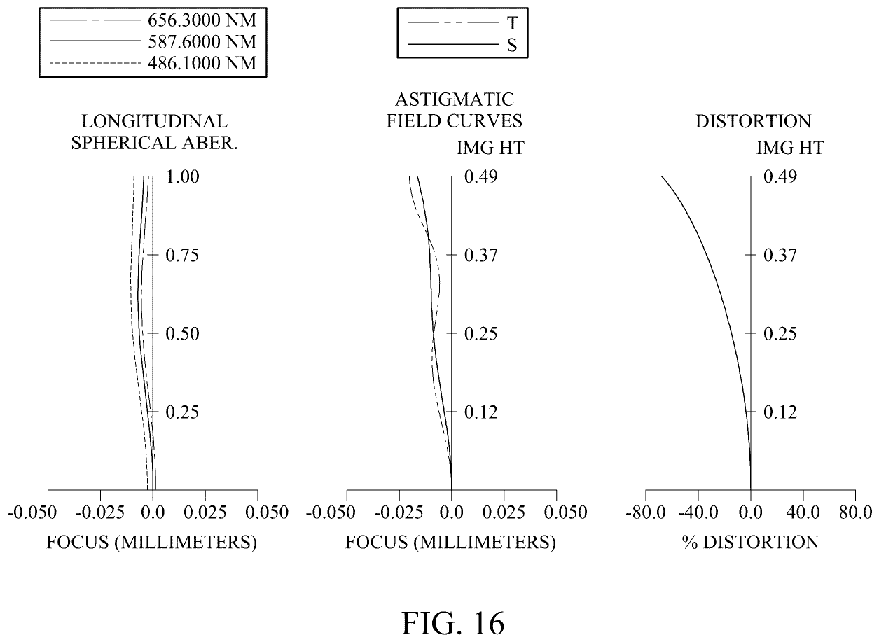

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the photographing optical lens system (its reference numeral is omitted) of the present disclosure and an image sensor IS. The photographing optical lens system includes, in order from an object side to an image side along an optical path, a first plate E4, a first lens element E1, an aperture stop ST, a second lens element E2, a third lens element E3, a second plate E5, a filter E6 and an image surface IMG. The photographing optical lens system includes three lens elements (E1, E2 and E3) with no additional lens element disposed between each of the adjacent three lens elements.

The first plate E4 is made of glass material and located between an imaged object and the first lens element E1, and will not affect the focal length of the photographing optical lens system.

The first lens element E1 with negative refractive power has an object-side surface being planar in a paraxial region thereof and an image-side surface being concave in a paraxial region thereof. The first lens element E1 is made of plastic material and has the object-side surface being spherical and the image-side surface being aspheric. The object-side surface of the first lens element E1 is cemented to the first plate E4.

The second lens element E2 with positive refractive power has an object-side surface being convex in a paraxial region thereof and an image-side surface being convex in a paraxial region thereof. The second lens element E2 is made of plastic material and has the object-side surface and the image-side surface being both aspheric.

The third lens element E3 with negative refractive power has an object-side surface being concave in a paraxial region thereof and an image-side surface being planar in a paraxial region thereof. The third lens element E3 is made of glass material and has the object-side surface being aspheric and the image-side surface being spherical. The image-side surface of the third lens element E3 is cemented to the second plate E5.

The second plate E5 is made of glass material and located between the third lens element E3 and the image surface IMG, and will not affect the focal length of the photographing optical lens system.

The filter E6 is made of glass material and located between the second plate E5 and the image surface IMG, and will not affect the focal length of the photographing optical lens system. The filter E6 is cemented to the second plate E5. The image sensor IS is disposed on or near the image surface IMG of the photographing optical lens system.

The detailed optical data of the 8th embodiment are shown in Table 8A and the aspheric surface data are shown in Table 8B below.

TABLE 8A
8th Embodiment
f = 0.55 mm, Fno = 4.70, HFOV = 70.1 deg.

| Surface # | | Curvature Radius | | Thickness | Material | Index | Abbe # | Focal Length |
|---|---|---|---|---|---|---|---|---|
| 0 | Object | Infinity | | 20.000 | | | | |
| 1 | Plate 1 | Plano | | 0.100 | Glass | 1.517 | 64.2 | — |
| 2 | | Plano | | 0.010 | Cement | 1.485 | 53.2 | |
| 3 | Lens 1 | Plano | (SPH) | 0.216 | Plastic | 1.587 | 28.3 | −0.93 |
| 4 | | 0.5467 | (ASP) | 0.324 | | | | |
| 5 | Ape. Stop | Plano | | 0.034 | | | | |
| 6 | Lens 2 | 0.4060 | (ASP) | 0.280 | Plastic | 1.534 | 56.0 | 0.31 |
| 7 | | −0.2071 | (ASP) | 0.110 | | | | |
| 8 | Lens 3 | −0.2626 | (ASP) | 0.150 | Glass | 1.699 | 30.1 | −0.38 |
| 9 | | Plano | (SPH) | 0.010 | Cement | 1.485 | 53.2 | |

| | | | | | | | |
|---|---|---|---|---|---|---|---|
| 10 | Plate 2 | Plano | 0.300 | Glass | 1.517 | 64.2 | — |
| 11 | | Plano | 0.010 | Cement | 1.485 | 53.2 | |
| 12 | Filter | Plano | 0.100 | Glass | 1.517 | 64.2 | — |
| 13 | | Plano | 0.092 | | | | |
| 14 | Image | Plano | — | | | | |

Note:
Reference wavelength is 587.6 nm (d-line).

TABLE 8B
Aspheric Coefficients

| Surface # | 4 | 6 | 7 | 8 |
|---|---|---|---|---|
| k= | 1.02072E+00 | −1.07166E+00 | −5.79776E−01 | −1.20383E+00 |
| A4= | 4.9250E+00 | −2.1079E+00 | 1.5877E+01 | 2.0489E+01 |
| A6= | −3.3315E+01 | −9.5451E+02 | 3.1449E+02 | −3.9737E+02 |
| A8= | 1.9174E+03 | 1.0717E+05 | −3.0852E+04 | −1.1632E+03 |
| A10= | −3.0546E+04 | −5.5236E+06 | 1.1898E+06 | 2.3135E+05 |
| A12= | 2.2885E+05 | 1.0093E+08 | −2.5080E+07 | −6.1719E+06 |
| A14= | — | — | 2.0517E+08 | 4.4844E+07 |

In the 8th embodiment, the equation of the aspheric surface profiles of the aforementioned lens elements is the same as the equation of the 1st embodiment. Also, the definitions of these parameters shown in Table 8C below are the same as those stated in the 1st embodiment with corresponding values for the 8th embodiment, so an explanation in this regard will not be provided again.

Moreover, these parameters can be calculated from Table 8A and Table 8B as the following values and satisfy the following conditions:

TABLE 8C
Values of Optical and Physical Parameters/Definitions

| | | | |
|---|---|---|---|
| f [mm] | 0.55 | f1/R2 | −1.70 |
| Fno | 4.70 | R5/R4 | 1.27 |
| HFOV [deg.] | 70.1 | R5/R6 | 0.00 |
| FOV [deg.] | 140.2 | CT1/CT2 | 0.77 |
| TL/f | 2.94 | CT2/CT3 | 1.87 |
| ImgH/f | 0.89 | T12/CT1 | 1.66 |
| BL/TD | 0.46 | T23/CT2 | 0.39 |
| f/f1 | −0.59 | T23/CT3 | 0.73 |
| f/f3 | −1.47 | (CT2 + CT3)/CT1 | 1.99 |
| f/f12 | 2.20 | ET3/ET1 | 0.73 |
| f/f1 + f/f2 + f/f3 | −0.25 | Y1R2/Y2R1 | 1.82 |
| f/R1 + f/R6 | 0.00 | SAG3R2/CT3 | 0.00 |

### 9th Embodiment

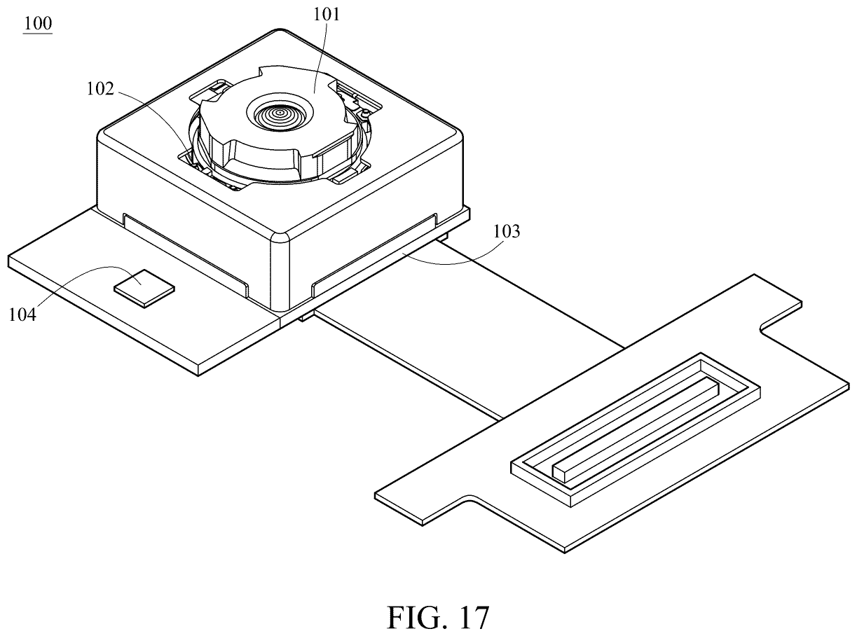

FIG. 17 is a perspective view of an image capturing unit according to the 9th embodiment of the present disclosure. In this embodiment, an image capturing unit 100 is a camera module including a lens unit 101, a driving device 102, an image sensor 103 and an image stabilizer 104. The lens unit 101 includes the photographing optical lens system as disclosed in the 1st embodiment, a barrel and a holder member (their reference numerals are omitted) for holding the photographing optical lens system. However, the lens unit 101 may alternatively be provided with the photographing optical lens system as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of voice coil motors (VCM), micro electro-mechanical systems (MEMS), piezoelectric systems or shape memory alloy materials. The driving device 102 is favorable for obtaining a better imaging position of the lens unit 101, so that a clear image of the imaged object can be captured by the lens unit 101 with different object distances. The image sensor 103 (for example, CMOS or CCD), which can feature high photosensitivity and low noise, is disposed on the image surface of the photographing optical lens system to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions.

### 10th Embodiment

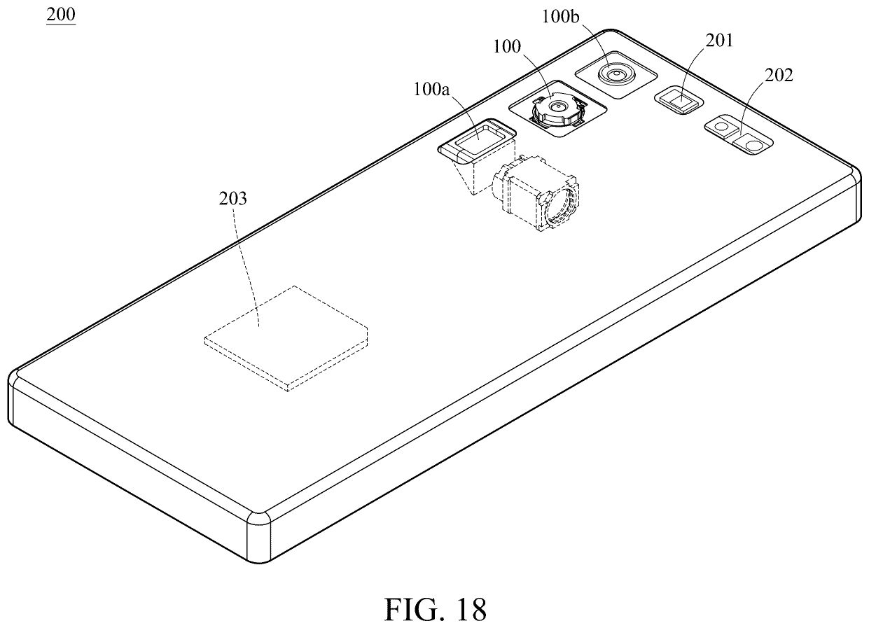

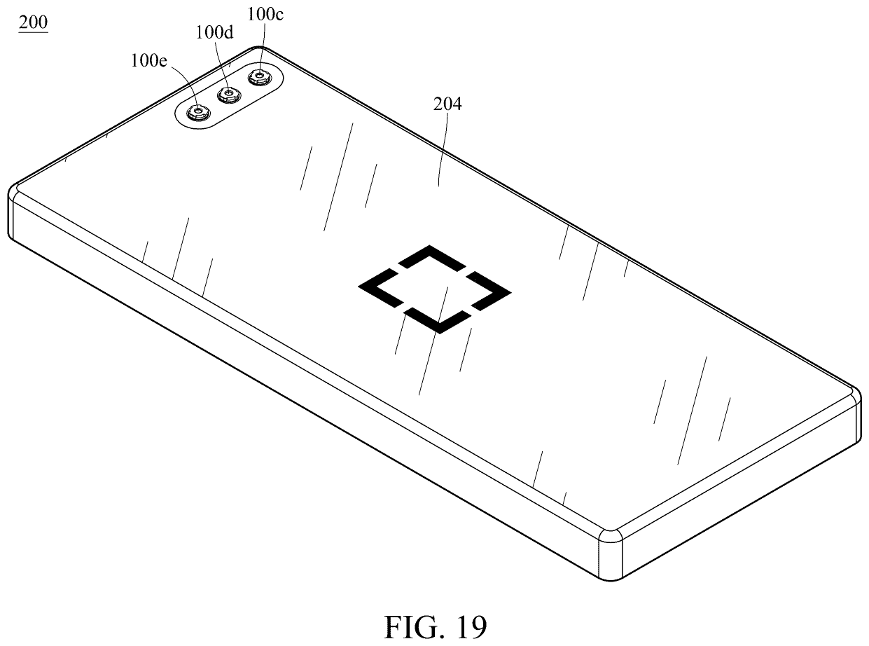

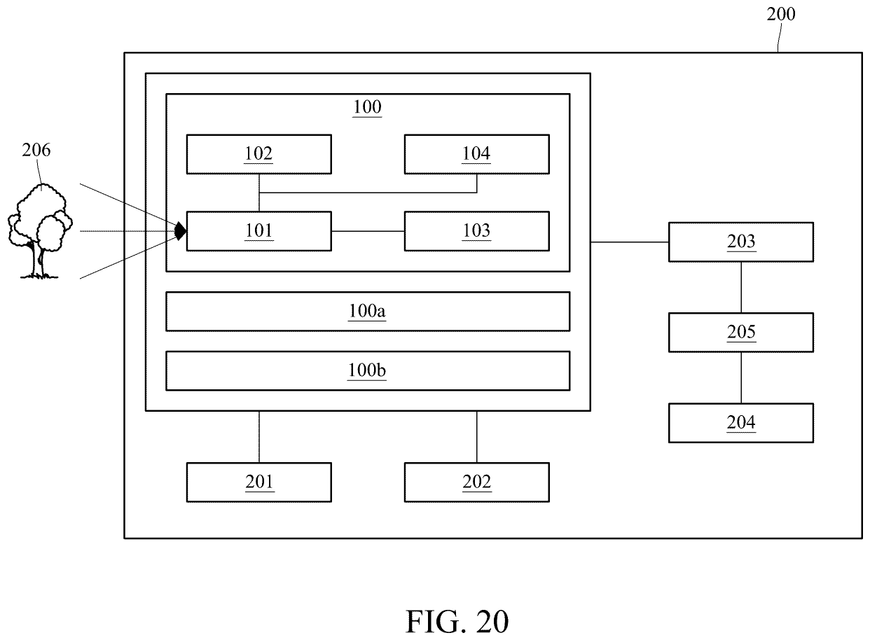

FIG. 18 is one perspective view of an electronic device according to the 10th embodiment of the present disclosure, FIG. 19 is another perspective view of the electronic device in FIG. 18, and FIG. 20 is a block diagram of the electronic device in FIG. 18.

In this embodiment, an electronic device 200 is a smartphone including the image capturing unit 100 as disclosed in the 9th embodiment, an image capturing unit 100a, an image capturing unit 100b, an image capturing unit 100c, an image capturing unit 100d, an image capturing unit 100e, a flash module 201, a focus assist module 202, an image signal processor 203, a display module 204 and an image software processor 205. The image capturing unit 100, the image capturing unit 100a and the image capturing unit 100b are disposed on the same side of the electronic device 200, and each of the image capturing units 100, 100a and 100b has a single focal point. The focus assist module 202 can be a laser rangefinder or a ToF (time of flight) module, but the present disclosure is not limited thereto. The image capturing unit 100c, the image capturing unit 100d, the image capturing unit 100e and the display module 204 are disposed on the opposite side of the electronic device 200, and the display module 204 can be a user interface, such that the image capturing units 100c, 100d and 100e can be front-facing cameras of the electronic device 200 for taking selfies, but the present disclosure is not limited thereto. Furthermore, each of the image capturing units 100a, 100b, 100c, 100d and 100e can include the photographing optical lens system of the present disclosure and can have a configuration similar to that of the image capturing unit 100. In detail, each of the image capturing units 100a, 100b, 100c, 100d and 100e can include a lens unit, a driving device, an image sensor and an image stabilizer, and can also include a light-folding element for folding optical path. In addition, each lens unit of the image capturing units 100a, 100b, 100c, 100d and 100e can include the photographing optical lens system of the present disclosure, a barrel and a holder member for holding the photographing optical lens system.

The image capturing unit 100 is a wide-angle image capturing unit, the image capturing unit 100a is a telephoto image capturing unit with optical path folding function, the image capturing unit 100b is an ultra-wide-angle image capturing unit, the image capturing unit 100c is a wide-angle image capturing unit, the image capturing unit 100d is an ultra-wide-angle image capturing unit, and the image capturing unit 100e is a ToF image capturing unit. In this embodiment, the image capturing units 100, 100a and 100b have different fields of view, such that the electronic device 200 can have various magnification ratios so as to meet the requirement of optical zoom functionality. In addition, the image capturing unit 100e can determine depth information of the imaged object. Moreover, the light-folding configuration of the image capturing unit 100a can be similar to, for example, one of the configurations as shown in FIG. 27 to FIG. 29, which can be referred to foregoing descriptions corresponding to FIG. 27 to FIG. 29, and the details in this regard will not be provided again. Moreover, each of the image capturing units 100, 100b, 100c, 100d and 100e can have a light-folding configuration similar to, for example, one of the configurations as shown in FIG. 27 to FIG. 29, which can be referred to foregoing descriptions corresponding to FIG. 27 to FIG. 29. In this embodiment, the electronic device 200 includes multiple image capturing units 100, 100a, 100b, 100c, 100d and 100e, but the present disclosure is not limited to the number and arrangement of image capturing units.

When a user captures images of an object 206, the light rays converge in the image capturing unit 100, the image capturing unit 100a or the image capturing unit 100b to generate images, and the flash module 201 is activated for light supplement. The focus assist module 202 detects the object distance of the imaged object 206 to achieve fast auto focusing. The image signal processor 203 is configured to optimize the captured image to improve image quality. The light beam emitted from the focus assist module 202 can be either conventional infrared or laser. In addition, the light rays may converge in the image capturing unit 100c, 100d or 100e to generate images. The display module 204 can include a touch screen, and the user is able to interact with the display module 204 and the image software processor 205 having multiple functions to capture images and complete image processing. Alternatively, the user may capture images via a physical button. The image processed by the image software processor 205 can be displayed on the display module 204.

### 11th Embodiment

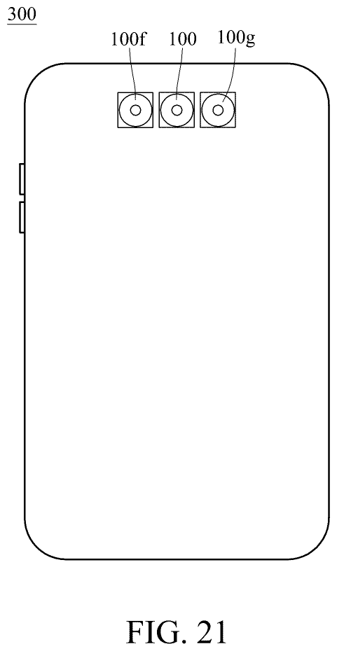

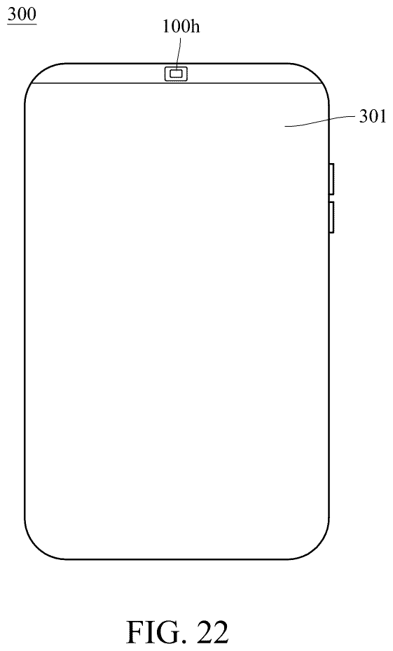

FIG. 21 is one schematic view of an electronic device according to the 11th embodiment of the present disclosure, and FIG. 22 is another schematic view of the electronic device in FIG. 21.

In this embodiment, an electronic device 300 is a smartphone including the image capturing unit 100 as disclosed in the 9th embodiment, an image capturing unit 100f, an image capturing unit 100g, an image capturing unit 100h and a display module 301. As shown in FIG. 21, the image capturing unit 100, the image capturing unit 100f and the image capturing unit 100g are disposed on the same side of the electronic device 300, and each of the image capturing units 100, 100f and 100g has a single focal point. As shown in FIG. 22, the image capturing unit 100h and the display module 301 are disposed on the opposite side of the electronic device 300, such that the image capturing unit 100h can be a front-facing camera of the electronic device 300 for taking selfies, but the present disclosure is not limited thereto. Furthermore, each of the image capturing units 100f, 100g and 100h can include the photographing optical lens system of the present disclosure and can have a configuration similar to that of the image capturing unit 100. In detail, each of the image capturing units 100f, 100g and 100h can include a lens unit, a driving device, an image sensor and an image stabilizer. In addition, each lens unit of the image capturing units 100f, 100g and 100h can include the photographing optical lens system of the present disclosure, a barrel and a holder member for holding the photographing optical lens system.

The image capturing unit 100 is a wide-angle image capturing unit, the image capturing unit 100f is a telephoto image capturing unit, the image capturing unit 100g is an ultra-wide-angle image capturing unit, and the image capturing unit 100h is a wide-angle image capturing unit. In this embodiment, the image capturing units 100, 100f and 100g have different fields of view, such that the electronic device 300 can have various magnification ratios so as to meet the requirement of optical zoom functionality. In this embodiment, the electronic device 300 includes multiple image capturing units 100, 100f, 100g and 100h, but the present disclosure is not limited to the number and arrangement of image capturing units.

### 12th Embodiment

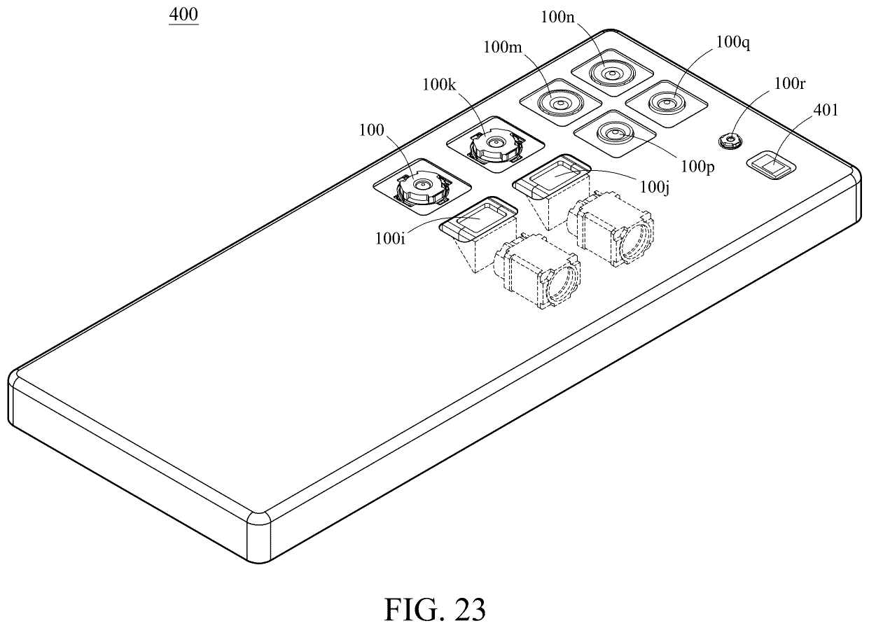

FIG. 23 is one perspective view of an electronic device according to the 12th embodiment of the present disclosure.

In this embodiment, an electronic device 400 is a smartphone including the image capturing unit 100 as disclosed in the 9th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the photographing optical lens system of the present disclosure and can have a configuration similar to that of the image capturing unit 100, and the details in this regard will not be provided again.

The image capturing unit 100 is a wide-angle image capturing unit, the image capturing unit 100i is a telephoto image capturing unit with optical path folding function, the image capturing unit 100j is a telephoto image capturing unit with optical path folding function, the image capturing unit 100k is a wide-angle image capturing unit, the image capturing unit 100m is an ultra-wide-angle image capturing unit, the image capturing unit 100n is an ultra-wide-angle telephoto image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p and 100q have different fields of view, such that the electronic device 400 can have various magnification ratios so as to meet the requirement of optical zoom functionality. In addition, the image capturing unit 100r can determine depth information of the imaged object. Moreover, the light-folding configuration of the image capturing units 100i and 100j can be similar to, for example, one of the structures shown in FIG. 27 to FIG. 29, which can be referred to foregoing descriptions corresponding to FIG. 27 to FIG. 29, and the details in this regard will not be provided again. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

### 13th Embodiment

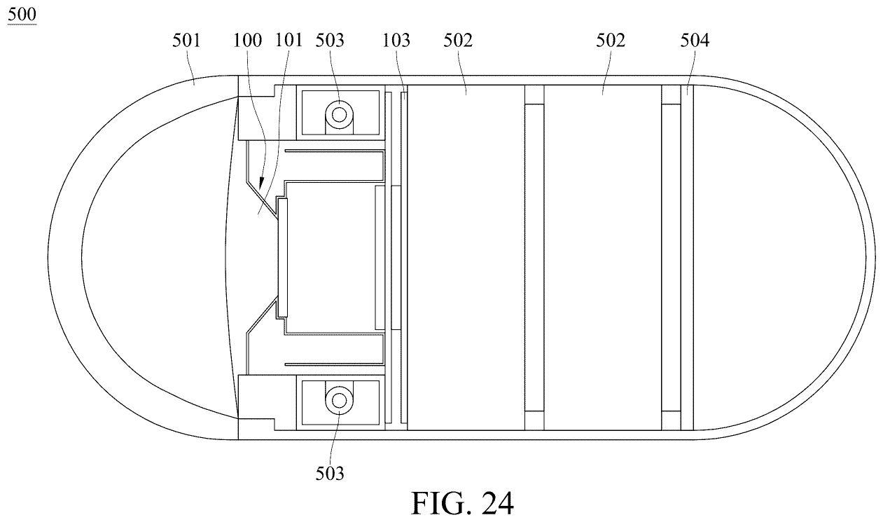

FIG. 24 is one perspective view of an electronic device according to the 13th embodiment of the present disclosure.

In this embodiment, an electronic device 500 is a capsule endoscope including a housing 501, a plurality of batteries 502, a plurality of light-emitting diodes 503, the image capturing unit 100 as disclosed in the 9th embodiment, and a wireless transmitter 504. The batteries 502, the light-emitting diodes 503, the image capturing unit 100 and the wireless transmitter 504 are disposed in the housing 501. In addition, the lens unit 101 of the image capturing unit 100 is disposed on one side of the light-emitting diodes 503. Furthermore, the image sensor 103 of the image capturing unit 100 is, for example, a CMOS. The batteries 502 supply power to the light-emitting diodes 503, the image capturing unit 100, and the wireless transmitter 504. The light-emitting diodes 503 is configured to emit light towards an imaged object, allowing the image capturing unit 100 to capture clear images. The images are then converted into image signals, which are transmitted via the wireless transmitter 504 to outside the human body. A wireless receiving antenna (not shown) located outside the human body receives the image signals, and the images of the imaged object can be displayed on a display device (not shown). Moreover, the photographing optical lens system of the image capturing unit 100 is configured for capturing images of the imaged object when an object distance is, for example, within a range of 30 mm or less.

### 14th Embodiment

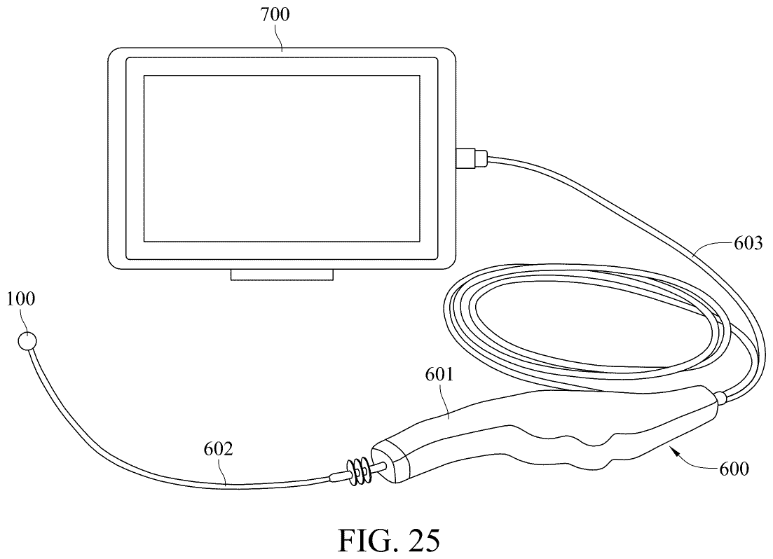

FIG. 25 is one perspective view of an electronic device according to the 14th embodiment of the present disclosure.

In this embodiment, an electronic device 600 is a nasopharyngeal endoscope including a main body 601, a first cable 602, the image capturing unit 100 as disclosed in the 9th embodiment, and a second cable 603. One end of the first cable 602 is electrically connected to the main body 601, and the image capturing unit 100 is disposed on another end of the first cable 602. Moreover, the photographing optical lens system of the image capturing unit 100 is configured for capturing images of an imaged object when an object distance is, for example, within a range of 30 mm or less. One end of the second cable 603 is electrically connected to the main body 601, and another end of the second cable 603 is electrically connected to a display device 700, but the present disclosure is not limited thereto. The electronic device 600 captures clear images through the image capturing unit 100, converts the images into image signals, and transmits the image signals through the first cable 602 and the second cable 603 to the display device 700 to show the images of the imaged object.

The smartphones and the endoscopes in the embodiments are only exemplary for showing the image capturing unit of the present disclosure installed in an electronic device, and the present disclosure is not limited thereto. The image capturing unit can be optionally applied to optical systems with a movable focus. Furthermore, the photographing optical lens system of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, unmanned aerial vehicles, wearable devices, portable video recorders, various medical endoscopes, industrial endoscopes, capsule cameras, and other electronic imaging devices.

The foregoing description, for the purpose of explanation, has been described with reference to specific embodiments. It is to be noted that TABLES 1A-8C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A photographing optical lens system comprising three lens elements, the three lens elements being, in order from an object side to an image side along an optical path, a first lens element, a second lens element and a third lens element, and each of the three lens elements having an object-side surface facing toward the object side and an image-side surface facing toward the image side;
wherein the image-side surface of the first lens element is concave in a paraxial region thereof, the third lens element has negative refractive power, and the photographing optical lens system further comprises an aperture stop disposed between the first lens element and the second lens element; and
wherein an axial distance between the object-side surface of the first lens element and an image surface is TL, a focal length of the photographing optical lens system is f, a central thickness of the first lens element is CT1, a central thickness of the second lens element is CT2, a central thickness of the third lens element is CT3, a curvature radius of the object-side surface of the third lens element is R5, a curvature radius of the image-side surface of the third lens element is R6, an f-number of the photographing optical lens system is Fno, and the following conditions are satisfied:
$$\begin{matrix}1.8 < TL / f < 5.1 ; \\ 1.75 < ( CT 2 + CT 3 ) / CT 1 < 6.5 ; \\ 0.4 < CT 2 / CT 3 < 2.5 ; \\ - 1.2 < R 5 / R 6 < 0.39 ; and \\ 2.6 < Fno < 5.1 .\end{matrix}$$

2. The photographing optical lens system of claim 1, wherein the second lens element has positive refractive power, the object-side surface of the second lens element is convex in a paraxial region thereof, the image-side surface of the second lens element is convex in a paraxial region thereof, and the object-side surface of the third lens element is concave in a paraxial region thereof.

3. The photographing optical lens system of claim 1, wherein the first lens element has negative refractive power; and
wherein an axial distance between the second lens element and the third lens element is T23, the central thickness of the third lens element is CT3, and the following condition is satisfied:
$$0.03 < T 23 / CT 3 < 3. .$$

4. The photographing optical lens system of claim 1, wherein the focal length of the photographing optical lens system is f, a focal length of the first lens element is f1, a focal length of the second lens element is f2, a focal length of the third lens element is f3, the central thickness of the first lens element is CT1, the central thickness of the second lens element is CT2, and the following conditions are satisfied:
$$- 1.5 < f / f 1 + f / f 2 + f / f 3 < 0.2 ; and$$
$$0.15 < CT 1 / CT 2 < 1.05 .$$

5. The photographing optical lens system of claim 1, wherein a maximum image height of the photographing optical lens system is ImgH, the focal length of the photographing optical lens system is f, an axial distance between the image-side surface of the third lens element and the image surface is BL, an axial distance between the object-side surface of the first lens element and the image-side surface of the third lens element is TD, and the following conditions are satisfied:
$$0.65 < ImgH / f < 1.5 ; and$$
$$0.1 < BL / TD < 0. 60 .$$

6. The photographing optical lens system of claim 1, wherein the focal length of the photographing optical lens system is f, a focal length of the third lens element is f3, a maximum field of view of the photographing optical lens system is FOV, and the following conditions are satisfied:
$$- 3.00 < f / f 3 < - 0.3 ; and$$
$$128. degrees < FOV < 172. degrees .$$

7. The photographing optical lens system of claim 1, wherein an axial distance between the first lens element and the second lens element is T12, the central thickness of the first lens element is CT1, and the following condition is satisfied:
$$1. 20 < T 12 / CT 1 < 5.00 .$$

8. The photographing optical lens system of claim 1, wherein at least one of the object-side surface of the first lens element and the image-side surface of the third lens element is planar in a paraxial region thereof.

9. The photographing optical lens system of claim 1, wherein a displacement in parallel with an optical axis from an axial vertex of the image-side surface of the third lens element to a maximum effective radius position of the image-side surface of the third lens element is SAG3R2, the central thickness of the third lens element is CT3, and the following condition is satisfied:
$$- 0.30 < SAG 3 R 2 / CT 3 < 0.35 .$$

10. An image capturing unit comprising:
the photographing optical lens system of claim 1; and
an image sensor disposed on the image surface of the photographing optical lens system.

11. An electronic device comprising:
the image capturing unit of claim 10.

12. A photographing optical lens system comprising three lens elements, the three lens elements being, in order from an object side to an image side along an optical path, a first lens element, a second lens element and a third lens element, and each of the three lens elements having an object-side surface facing toward the object side and an image-side surface facing toward the image side;
wherein the third lens element has negative refractive power; and
wherein an axial distance between the object-side surface of the first lens element and an image surface is TL, a focal length of the photographing optical lens system is f, a composite focal length of the first lens element and the second lens element is f12, a central thickness of the first lens element is CT1, a central thickness of the second lens element is CT2, a central thickness of the third lens element is CT3, an axial distance between the first lens element and the second lens element is T12, a curvature radius of the object-side surface of the first lens element is R1, a curvature radius of the image-side surface of the second lens element is R4, a curvature radius of the object-side surface of the third lens element is R5, a curvature radius of the image-side surface of the third lens element is R6, and the following conditions are satisfied:
$$2.3 < TL / f < 4.8 ;$$
$$1.75 < ( CT 2 + CT 3 ) / CT 1 < 6 \text{.50} ;$$
$$1.2 < T 12 / CT 1 < 4 \text{.20} ;$$
$$0.5 < R 5 / R 4 < 3 \text{.30} ;$$
$$- 0.6 \; 0 < f / R 1 + f / R 6 < 1.5 ; and$$
$$0.9 < f / f 12 < 4.00 .$$

13. The photographing optical lens system of claim 12, wherein the focal length of the photographing optical lens system is f, a focal length of the first lens element is f1, and the following condition is satisfied:
$$- 1.5 < f / f 1 < 0. 20 .$$

14. The photographing optical lens system of claim 12, wherein an axial distance between the second lens element and the third lens element is T23, the central thickness of the second lens element is CT2, and the following condition is satisfied:
$$0.03 < T 23 / CT 2 < 1. .$$

15. The photographing optical lens system of claim 12, wherein the first lens element has negative refractive power; and
wherein the focal length of the photographing optical lens system is f, the composite focal length of the first lens element and the second lens element is f12, and the following condition is satisfied:
$$1. 25 < f / f 12 < 3.30 .$$

16. The photographing optical lens system of claim 12, wherein the photographing optical lens system is configured for capturing an image of an imaged object when an object distance is within a range of 30 mm or less; and
wherein a maximum field of view of the photographing optical lens system is FOV, and the following condition is satisfied:
$$125. degrees < FOV < 175. degrees .$$

17. The photographing optical lens system of claim 12, wherein the curvature radius of the object-side surface of the third lens element is R5, the curvature radius of the image-side surface of the third lens element is R6, an axial distance between the second lens element and the third lens element is T23, the central thickness of the third lens element is CT3, and the following conditions are satisfied:
$$- 2.00 < R 5 / R 6 < 0.35 ; and$$
$$0.03 < T 23 / CT 3 < 3.00 .$$

18. The photographing optical lens system of claim 12, wherein an axial distance between the image-side surface of the third lens element and the image surface is BL, an axial distance between the object-side surface of the first lens element and the image-side surface of the third lens element is TD, and the following condition is satisfied:
$$0.1 < BL / TD < 0.60 .$$

19. The photographing optical lens system of claim 12, wherein a focal length of the first lens element is f1, a curvature radius of the image-side surface of the first lens element is R2, the central thickness of the second lens element is CT2, the central thickness of the third lens element is CT3, and the following conditions are satisfied:
$$- 3.50 < f 1 / R 2 < 0. ; and$$
$$0.55 < CT 2 / CT 3 < 2.40 .$$

20. The photographing optical lens system of claim 12, wherein a maximum effective radius of the image-side surface of the first lens element is Y1R2, a maximum effective radius of the object-side surface of the second lens element is Y2R1, a distance in parallel with an optical axis between a maximum effective radius position of the object-side surface of the first lens element and a maximum effective radius position of the image-side surface of the first lens element is ET1, a distance in parallel with the optical axis between a maximum effective radius position of the object-side surface of the third lens element and a maximum effective radius position of the image-side surface of the third lens element is ET3, and the following conditions are satisfied:
$$0.95 < Y 1 R 2 / Y 2 R 1 < 2. ; and$$
$$0.5 < ET 3 / ET 1 < 2.50 .$$

21. The photographing optical lens system of claim 12, wherein the axial distance between the object-side surface of the first lens element and the image surface is TL, the focal length of the photographing optical lens system is f, the composite focal length of the first lens element and the second lens element is f12, the central thickness of the first lens element is CT1, the central thickness of the second lens element is CT2, the central thickness of the third lens element is CT3, the curvature radius of the object-side surface of the first lens element is R1, the curvature radius of the image-side surface of the second lens element is R4, the curvature radius of the object-side surface of the third lens element is R5, the curvature radius of the image-side surface of the third lens element is R6, an f-number of the photographing optical lens system is Fno, the axial distance between the first lens element and the second lens element is T12, and the following conditions are satisfied:
$$2.5 \leq TL / f \leq 4.45 ;$$
$$1.99 \leq ( CT 2 + CT 3 ) / CT 1 \leq 5 \text{.72} ;$$
$$0.85 \leq CT 2 / CT 3 \leq 2 \text{.09} ;$$
$$- 0.5 \; 4 \leq R 5 / R 6 \leq 0 \text{.20} ;$$
$$3.3 \leq Fno \leq 4.7 ;$$
$$1.66 \leq T 12 / CT 1 \leq 3 \text{.85} ;$$
$$1.19 \leq R 5 / R 4 \leq 2 \text{.55} ;$$
$$- 0.3 \; 2 \leq f / R 1 + f / R 6 \leq 0.9 ; and$$
$$1.67 \leq f / f 12 \leq 2.93 .$$
